(19) United States
(12) Patent Application Publication
(10) Pub. No.: US 2022/0236187 A1
(43) Pub. Date: Jul. 28, 2022

(54) SYSTEM AND METHOD FOR REAL-TIME MULTICOLOR SHORTWAVE INFRARED FLUORESCENCE IMAGING

(71) Applicants: HELMHOLTZ ZENTRUM MÜNCHEN - DEUTSCHES FORSCHUNGSZENTRUM FÜR GESUNDHEIT UND UMWELT (GMBH), Neuherberg (DE); THE REGENTS OF THE UNIVERSITY OF CALIFORNIA, Oakland, CA (US)

(72) Inventors: Oliver BRUNS, Neuherberg (DE); Jakob LINGG, Neuherberg (DE); Martin WARMER, Neuherberg (DE); Shyam S. RAMAKRISHNAN, Neuherberg (DE); Mara SACCOMANO, Neuherberg (DE); Ellen SLETTEN, East Los Angeles, CA (US); Emily COSCO, East Los Angeles, CA (US)

(73) Assignees: HELMHOLTZ ZENTRUM MÜNCHEN - DEUTSCHES FORSCHUNGSZENTRUM FÜR GESUNDHEIT UND UMWELT (GMBH), Neuherberg (DE); THE REGENTS OF THE UNIVERSITY OF CALIFORNIA, Oakland, CA (US)

(21) Appl. No.: 17/617,190

(22) PCT Filed: Jun. 7, 2020
(86) PCT No.: PCT/EP2020/065753

§ 371 Date: Dec. 7, 2021

Related U.S. Application Data
(60) Provisional application No. 62/858,440, filed on Jun. 7, 2019.

(51) Int. Cl. G01N 21/64

(52) U.S. Cl. CPC G01N 21/6456; G01N 2021/6439; G01N 2021/6419

(57) ABSTRACT

The present invention relates to systems, methods and fluorophores for real-time multicolor shortwave infrared fluorescence imaging. The systems and methods of the present invention further relate to real-time multi-color in vivo SWIR imaging systems employing high-power excitation sources in combination with state of the art InGaAs SWIR detectors and SWIR illuminated fluorophores.

### TECHNICAL FIELD

The shortwave infrared (SWIR, e.g., in the range 1000-2000 nm) region of the electromagnetic spectrum has provided a means to real-time monitoring of whole mammals with high contrast and resolution. While many inorganic and organic fluorophores have been developed for this region, multiplexed experiments have been limited due to near infrared (NIR, e.g., in the range 700-1000 nm) excitation wavelengths of often broad and overlapping absorption profiles. Polymethine dyes are a promising class of fluorophores for SWIR multiplexed imaging due to narrow absorption profiles and high absorption coefficients.

The present invention relates to systems (e.g., FIGS. 1 and 2), methods and suitable fluorophores (e.g., WO 2018/226720A1) for real-time multicolor/multiplexed shortwave infrared fluorescence imaging. The systems, methods and suitable fluorophores (e.g., WO 2018/226720A1) of the present invention further relate to real-time multi-color in vivo SWIR imaging systems employing high-power excitation sources in combination with state of the art SWIR detectors (e.g., InGaAs, HgCdTe or MCT, Germanium, superconducting nanowires, PbS sensitized silicon chips, bolometers, schottky barrier and pyroelectric detectors; or any other detector technology sensitive between 1000 and 2500 nm) and SWIR illuminated fluorophores (e.g., WO 2018/226720A1).

### BACKGROUND OF THE INVENTION

There exist systems that are capable of performing in vivo SWIR imaging (e.g., WO2017160639A1). The indium gallium arsenide (InGaAs) detectors are restricted for commercial use and are bound by law enforcement services due to their applications in military surveillance and weapon defense systems. These detectors also lag behind in commercial development due to the high associated development cost. However, there exist a number of commercially available high-throughput InGaAs detector-based camera systems.

The diode-based VIS (visible light), NIR or SWIR light sources are a mature technology, however the high power current driven VIS, NIR or SWIR light sources are safety critical apparatus and there exist relatively smaller number of system developers and service providers. The recent developments in this industry has resulted fiber-coupled light-sources with dedicated current controllable driver units.

The trigger control devices are common apparatus used for imaging in visible spectrum. However, there is no known system that provides complete integration of high-power VIS/NIR/SWIR light sources with SWIR detectors for the purpose of in vivo imaging of biological structures.

Prevailing in vivo real-time multicolor optical imaging systems employ visible or near-infrared spectrum for fluorescence imaging. When applied to characterize biological structures, such imaging apparatus provide sub-standard results due to higher photon scattering in biological tissues as opposed to the shortwave infrared (SWIR) imaging systems. The shortwave infrared imaging techniques provide better contrast and clarity in imaging due to higher transmission through biological tissues and reduced autofluorescence. However, the existing SWIR imaging systems are not capable of synthesizing a multicolor real-time in vivo imaging (e.g., acquiring 25 frames per second and faster) of biological structures. The excitation sources and detectors are not capable of handling external control for synchronized acquisition. The HDR imaging of biological structures is limited in existing SWIR imaging device and methods due to low throughput design of detectors. The controllability and scalability of the existing SWIR imaging apparatus are limited.

Additionally, a real-time multi-channel fluorescence imaging system (e.g., acquiring 25 frames per second and faster) in SWIR spectrum is not yet available for commercial use due to the technical challenges faced in the development of high-throughput SWIR detectors and SWIR targeted fluorophores.

### SUMMARY OF THE INVENTION

The present invention relates to a method for multiplexed and/or multicolor imaging (e.g., with VIS/NIR/SWIR fluorophores, preferably polymethine fluorophores/dyes, e.g., ICG and/or Julo7, e.g., WO 2018/226720A1) of a sample location, said method comprising:
i) exposing a portion of said sample location to a first light pulse/s (e.g., an excitation light pulse/s), wherein said first light pulse/s having:
   (a) a first state (e.g., said state has one or more of the properties of a wavelength and/or spectrum; e.g., linear, circular and elliptical polarization, intensity, incident angle and pulse length); or
   (b) a first wavelength;
   in order to illuminate (e.g., for reflectance imaging) or excite a first component (e.g., fluorescent component, e.g., VIS/NIR/SWIR fluorophores, preferably polymethine fluorophores/dyes, e.g., ICG, IRDye800CW, Julo5 and/or Julo7 (e.g., WO 2018/226720A1), or an autofluorescent tissue component, e.g., a pigment/s, preferably lipofuscin), chemical composition, surface and/or region in the portion of said sample location (e.g., a first dye comprised by the portion of said sample location);
ii) exposing the portion of said sample location to at least a second light pulse/s (e.g., a second excitation light pulse/s) having:
   (c) a second state (e.g., said state has one or more of the properties of a wavelength and/or spectrum; e.g., linear, circular and elliptical polarization, intensity, incident angle and pulse length), which is different from the first state of (a); or
   (d) a second wavelength, which is different from the first wavelength of (b);
   in order to illuminate (e.g., for reflectance imaging) or excite a second component (e.g., fluorescent component, e.g., VIS/NIR/SWIR fluorophores, preferably polymethine fluorophores/dyes, e.g., ICG, IRDye800CW, Julo5 and/or Julo7 (e.g., WO 2018/226720A1), or an autofluorescent tissue component, e.g., a pigment/s, preferably lipofuscin), chemical composition, surface and/or region in the portion of said sample location (e.g., a second dye comprised by the portion of said sample location), preferably said second component, chemical composition, surface or region is different from said first component, chemical composition, surface or region; wherein the first light pulse/s (e.g., the first excitation light pulse/s) and the second (and/or subsequent) light pulse/s (e.g. the second excitation light pulse/s) are provided sequentially;
iii) detecting light reflected or emitted by the first and the second component (e.g., fluorescent components or dyes e.g., ICG, IRDye800CW, Julo5 and/or Julo7 (e.g., WO 2018/226720A1), chemical composition, surface and/or region in the portion of said sample location (e.g., the first and the second fluorescent components or dyes, e.g., ICG, IRDye800CW, Julo5 and/or Julo7 (e.g., WO 2018/226720A1)) by an imaging device, wherein the peak emission wavelength of at least one component, chemical composition, surface and/or region in the portion of said sample location lies outside of the detection range of the imaging device, the detection process including:
   aa) switching the imaging device, in a sequential manner, between a first configuration (or state) during which the imaging device is responsive to a first electromagnetic radiation and a second configuration (or state) during which the imaging device is responsive to a second electromagnetic radiation (e.g., said first and second electromagnetic radiations are not identical); wherein the switching of the first configuration (or state) is triggered by the provision of the light pulse/s (e.g., by the means of provision of electrical pulses to the light sources).

The present invention further relates to systems for multiplexed and/or multicolor imaging (e.g., a fluorescent component, e.g., VIS/NIR/SWIR fluorophores, preferably polymethine fluorophores/dyes, e.g., ICG, IRDye8000 W, Julo5 and/or Julo7 (e.g., WO 2018/226720A1), or an autofluorescent tissue component, e.g. a pigment/s, preferably lipofuscin) of sample locations, said system comprising:
i) a first laser light source configured to operate at a first wavelength;
ii) at least a second light source (e.g., laser light source or LED) configured to operate at a second wavelength;
iii) an imaging device configured to detect electromagnetic radiation;
iv) a control unit coupled to the first laser light source, the second laser light source and the imaging device, wherein the control unit is configured to control the first laser light source to provide first excitation light pulse/s and to control the second laser light source to provide second excitation light pulse/s in sequential manner; wherein the control unit is further configured to switch the imaging device in a sequential manner, between a first state during which the imaging device is responsive to a first electromagnetic radiation and a second state during which the imaging device is responsive to a second electromagnetic radiation (e.g., said first and second electromagnetic radiations are not identical); wherein the system is configured such that the switching of the imaging device into the first state is triggered by the provision of the light pulse/s (e.g., by the means of provision of electrical pulses to the light sources).

The present application satisfies this demand by the provision of the methods, systems and suitable fluorophores (e.g., fluorescent component, e.g., VIS/NIR/SWIR fluorophores, preferably polymethine fluorophores/dyes, e.g., ICG, IRDye8000 W, Julo5 and/or Julo7 (e.g., WO 2018/226720A1), or an autofluorescent tissue component, e.g. pigment/s, preferably lipofuscin) as described herein below, characterized in the claims and illustrated by the appended Examples and Figures.

### BRIEF DESCRIPTION OF THE DRAWINGS

FIG. 1: First exemplary functional diagram of the imaging system of the present invention comprising a trigger unit and triggering algorithm; an excitation unit; a transmission unit and its calibration methodologies; a detection unit and its calibration methodologies; a control unit and algorithm for control and data acquisition; VIS/NIR/SWIR probes (not shown).

FIG. 2: Second exemplary functional diagram of the imaging system of the present invention comprising: a control unit, a trigger unit, an excitation unit, a transmission unit, a detection unit and a safety enclosure.

FIG. 3: Flowchart for generalized image acquisition algorithm in control unit.

FIG. 4: Exemplary schematic of microcontroller-based trigger unit implementation.

FIG. 5: Absolute Quantum Efficiency of Goldeye G032 Cool Camera (derived from the camera datasheet).

FIG. 6: The FIGS. 6A, 6B and 6C show images of an Indocyanine green sample acquired with constant detector exposure setting of 200 ms excited by a 785 nm wavelength light source. With constant light intensity, they are acquired for 10 ms, 69 ms and 148 ms light pulse durations respectively. The FIG. 6D shows the processed SWIR HDR image.

FIG. 7: Multicolor Real-time Image Acquisition in SWIR. The FIGS. 7A, 7B and 7C show merged frames of the awake mouse in motion imaged in real-time with two color spectra of 6 ms detector exposure duration. In this configuration, a frame rate of 50 fps is achieved with the developed system.

FIG. 8: Multicolor Real-time Image Acquisition in SWIR. The FIGS. 8A, 8B and 8C show merged frames representing peristatic motions of a narcotized mouse in real-time two-color spectrum. With detector exposure time of 6 ms, a compound frame rate of 50 fps is achieved with the developed system. The ability to image with two colors removes the necessity to draw overlays of SWIR information on a visible range image.

FIG. 9: Multicolor Real-time Image Acquisition in SWIR. The FIGS. 9A, 9B and 9C show merged frames representing the lymphatic system of a narcotized mouse in two-color real-time acquisition. With detector exposure time of 20 ms, a frame rate of 21 fps is achieved with the developed system. For this demonstration, ICG has been injected intradermally into footpads and the base tail. After 40 min, ICG has been observed to be efficiently conducted through the lymphatic vessels. Then, Julo7 micelles have been injected intravenously. The lymphatic functional imaging is later enhanced by the assignment of two distinct colors.

FIG. 10: Approach to achieve multicolor whole animal imaging in high spatial and temporal resolution by parallel advances in flavylium heptamethine fluorophore derivatives and whole animal excitation-multiplexing technologies.

FIG. 11: Synthetic route to 7-amino flavylium heptamethine derivatives.

FIG. 12: Photophysical properties of flavylium polymethine fluorophores. A) Flavylium polymethine dye scaffold B) Absorption wavelength maxima visualized graphically on the electromagnetic spectrum. C) Absorption profiles of selected polymethine dyes 1, 3, 7, 9, 10 D) Emission profiles of selected polymethine dyes 1, 3, 7, 9, 10. E) Tabulated photophysical properties of heptamethine dyes.

FIG. 13: Excitation-multiplexed SWIR imaging configuration. A) Absorption profiles of heptamethine dyes ICG (in ethanol), and 10 and 3 (in DCM), aligned with common laser wavelengths 785 nm, 980 nm, and 1064 nm, respectively. B) A central trigger signal interface controls the excitation sources and InGaAs camera and integrates data with computer (PC). Sequential pulsed excitation light is delivered to the biological sample. Color-blind detection by the InGaAs camera collects frames which are separated temporally by color. The PC collects, stores, and displays raw data in real-time during image acquisition. C) Intensity profile of three successive frames and D) merged 3 color images of vials containing ICG in ethanol (left), 10 in DCM (center), and 3 in DCM (right). Dye concentrations were 0.004 mg/mL in the respective solvents. Samples were excited with laser wavelengths 785 nm, 980 nm, and 1064 nm. Frames were acquired with 5 ms exposure time, 33 fps, and collection between 1300-1700 nm. Raw and unmixed data are shown on the left, and right, respectively. D) Intensity plots of the data presented in (C).

FIG. 14: In vivo imaging with 1064 nm excitation. A) Whole mouse imaging at 100 fps, seconds after injection of 12 micelles, collection 1100-1700 nm. B) Close up of the hindlimb after 12 micelle injection, collection 1200-1700 nm. Yellow line indicates roi used in (C). C) Intensity profile of (B), demonstrating the contrast observed in veins and arteries versus diffuse tissue signal.

FIG. 15: Excitation-multiplexed SWIR imaging. A) Administration of three probes: emulsions of 10 i.p., and micelles of 3 and ICG i.v. B) Multiplexed in vivo images using 785 nm, 980 nm, and 1064 nm excitation, acquired at timepoints before and after injection of ICG. Collection occurred between 1150-1700 nm, with 10 ms exposure time, 27.8 fps. The contrasting biodistribution can be visualized over time in the merged images and in each individual wavelength channel.

FIG. 16: Applications enhanced by SWIR multiplexed imaging. A) Multiplexed imaging of an awake mouse, in 3 colors i.p. injection of 10 micelles, i.v. injection of ICG, and i.v injection of 3 micelles. Shown are closely acquired frames during one continuous movement of the head. Images were acquired with 785 nm, 980 nm, and 1064 nm ex. (110 mWcm⁻¹) and 1150-1700 nm collection (10 ms exposure time; 27.8 fps). B) Imaging of ICG clearance with systemic labelling by 3 micelles. Multiplexed in vivo images using 785 nm and 1064 nm ex. (100 mWcm⁻¹) and 1150-1700 nm collection (5 ms exposure time; 50 fps). C) Percent signal in the liver of ICG and micelles of 3 over one hour.

FIG. 17: Fluorophores in the context of excitation multiplexed SWIR imaging. a) Absorption properties of select fluorophores aligned with distinct excitation channels across the NIR and SWIR. b) Emission properties of select fluorophores across the NIR and SWIR overlaid with a SWIR detection window, defined here as 1000-1700 nm. Intensities are schematized to represent the key imaging concepts defined below. c) Existing fluorophores with high Φ_{F} (Φ_{F} in parenthesis) for their respective absorption wavelength aligned with the excitation channels defined in (a). d) Pentamethine and heptamethine fluorophores examined in this manuscript. Positions 2- and 7- on the flavylium and chromenylium heterocycles are indicated in red.

FIG. 18: Structures and photophysical properties of heptamethine and pentamethine dyes. a) Chemical structures of heptamethine and pentamethine dyes explored in this study. b) Absorption maxima of ICG and dyes 1-10 displayed graphically on the electromagnetic spectrum and aligned with the distinct excitation channels used for excitation-multiplexed, single-channel SWIR imaging. c) Absorbance spectra of newly reported dyes. d) Emission spectra of newly reported dyes. e-f) Quantum yields of heptamethine dyes (e) and pentamethine dyes (f) displayed graphically; error bars represent standard deviation. g) Table of photophysical properties.

FIG. 19: Analysis of heptamethine and pentamethine dye emissive properties. a) Table of photoluminescence lifetimes and rates. b-c) Time-correlated emission of selected dyes 2 and 6 (b) or 1 and 5 (c) and fitting curves. d) Chart outlining comparisons made between chromenylium and flavylium dyes for ΔΦ_{F} analysis in (e). e) Relative contribution of non-radiative rate (kₙᵣ), radiative rate (kᵣ), or a non-linear contribution (NL) composed of a combination of both kₙᵣ and kᵣ to ΔΦ_{F} between chromenylium and flavylium dyes (Note S3).

FIG. 20: Thermal Ellipsoid Plots (OTREP) for compound 4 (a) and 5 (b), arbitrary numbering, shown at two viewpoints. Bottoms structures omit all H atoms for clarity. Atomic displacement parameters are drawn at the 50% probability level.

FIG. 21: Brightness comparisons in imaging configuration. a-c) Images upon 785 (33 mWcm⁻²), 892 (54 mWcm⁻²), and 968 (77 mWcm⁻²) nm ex. and LP1000 nm detection (variable exposure time (ET) and frame rate) of capillaries containing equal moles of dyes 4-6, 9, 10 (lipid formulations) and benchmark dyes ICG (free) and MeOFlav7 (abbreviated MF7) (lipid formulation) when dissolved in water (a), fetal bovine serum (FBS) (b), or sheep blood (c). Displayed images were averaged over 200 frames and the intensities (averaged over Y-dimension in the image) are plotted over distance in the X-dimension below each image. d) Experimental timeline for the imaging experiment in e-f. e-f) Images after injection of ICG (50 nmol) upon 785 nm (64 mWcm⁻²) ex. (e) and after injection of JuloChrom5 (10) (50 nmol) upon 982 nm (104 mWcm⁻²) ex. (f). Collect: LP1000 nm, 2.0 ms ET, 150 fps (for 2-channel collection, see SI for images from all channels). Single frames at the time point which displayed the highest intensity over the whole mouse roi obtained during acquisition are displayed. g) Intensity quantification from images in e-f, taken by averaging intensity over the whole mouse at each frame after i.v. injection, where t=0 is the initial frame in which signal is visualized. h) Ratio of intensities (JuloChrom5 (10)/ICG) from rois quantified in e-f.

FIG. 22: High-speed three-color imaging. a) Experimental timeline for experiment in b-f. b) Single channel and composite images from three-color excitation multiplexed SWIR imaging at 100 fps. Injection amounts are as follows: Chrom5 (6)=130 nmol; JuloFlav5 (4)=80 nmol; Chrom7 (X)=110 nmol. Ex. 785 nm (80 mWcm⁻²). 892 nm (87 mWcm⁻²), 968 nm (94 mWcm⁻²), collect LP1000 nm, 3.3 ms, 100 fps, single frames are displayed. c-f) Intensity profiles over the heart (c-d) and the liver (e-f) from which the heart rate and breathing rate can be calculated, respectively. See SI for overlaid rois.

FIG. 23: Video-rate four-color imaging. a) Experimental timeline for experiment in (b) b) Composite images from four-color excitation multiplexed SWIR imaging at 30 fps. Injection amounts are as follows: ICG=200 nmol; JuloChrom5 (10)=50 nmol; Chrom7 (5)=45 nmol; JuloFlav7 (3)=45 nmol. Ex. 785 nm (45 mWcm⁻²). 892 nm (75 mWcm⁻²), 968 nm (103 mWcm⁻²), 1065 (156 mWcm⁻²); collect LP1100 nm, 7.8 ms, 30 fps, single frames are displayed.

### DETAILED DESCRIPTION OF THE INVENTION

The following detailed description refers to the accompanying Examples and Figures that show, by way of illustration, specific details and embodiments, in which the invention may be practiced. These embodiments are described in sufficient detail to enable those skilled in the art to practice the invention. Other embodiments may be utilized such that structural, logical, and eclectic changes may be made without departing from the scope of the invention. Various aspects of the present invention described herein are not necessarily mutually exclusive, as aspects of the present invention can be combined with one or more other aspects to form new embodiments of the present invention.

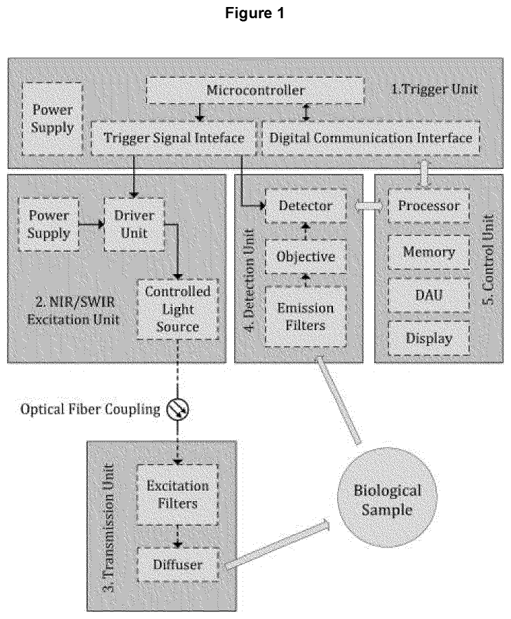

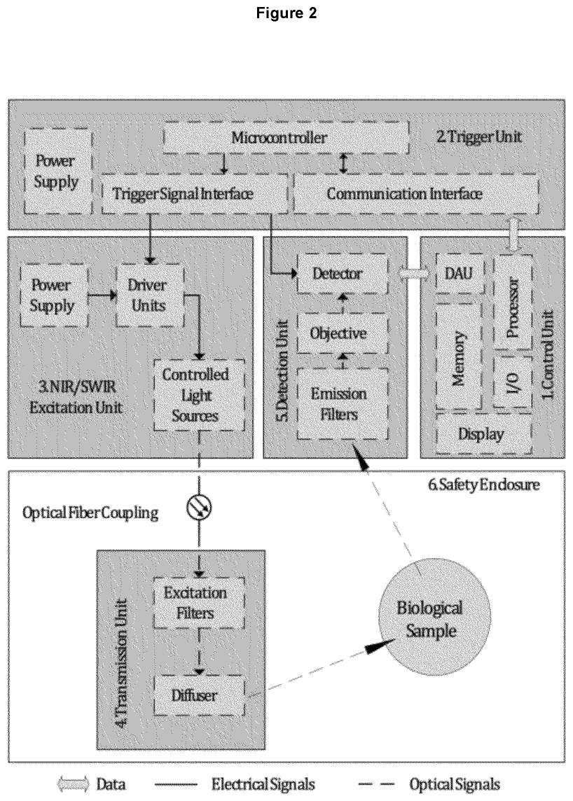

The present invention solves the challenges faced in the development of real-time multi-color in vivo SWIR imaging systems by employing high-power excitation sources in combination with state of the art InGaAs SWIR detectors and SWIR illuminated fluorophores. The developed system is capable of synchronizing the emission of light sources and SWIR detectors and acquire image data faster than the detectable movements of biological systems (e.g., FIGS. 1 and 2). The sequentially triggered excitation sources illuminate their corresponding fluorophores in the biological sample and detected by synchronized InGaAs detectors to achieve a multi-color SWIR imaging system. The synchronized emitter-detector imaging system also enables high-dynamic range (HDR) imaging and fluid flow-velocimetry mapping of biological structures in SWIR spectrum.

Exploiting a lead structure with bright SWIR emission, flavylium heptamethine dyes with varied substitution at the 7-position of the heterocycle were construed (e.g., as described in WO 2018/226720 A1). The resulting class comprises bright fluorophores with varied excitation wavelengths. The most blue-shifted derivative has a 7-methoxy substituent and absorption at 984 nm, while the most red-shifted derivative, containing a julolidine moiety, absorbs at 1061 nm. These dyes were encapsulated in soft nanomaterials and employed, along with indocyanine green, for excitation-multiplexed imaging in real-time and with high resolution in mice. SWIR multiplexed imaging was enabled to monitor awake mice, hepatic clearance, and orthogonal detection of the lymph and circulatory systems.

### Definitions

Unless otherwise specified, the terms used herein have their common general meaning as known in the art.

The term “shortwave infrared” used interchangeably with “SWIR” as used herein refers to a portion of the electromagnetic spectrum generally bound between wavelengths of approximately 900 nm and 2500 nm (e.g., preferably in the range 1000-2000 nm). The SWIR light range from 900 nm to 2500 nm is a generally accepted range and is not meant to be definitively limiting in any way.

The term “multiplexed imaging” as used herein refers to an imaging technique in which information (e.g., a signal, e.g., reflected or emitted light) is obtained or acquired simultaneously and/or sequentially and/or synchronically from various different sources (e.g., reflective structures, fluorophores or dyes). In preferred non-limiting embodiments, said multiplexed imaging is an excitation-multiplexed imaging (e.g., excitation-multiplexing enables a single “color-blind” detection source to be used, while excitation sources are modulated) and/or emission-multiplexed imaging (e.g., using multiple detectors with different optical filters to select for different emission bands).

The term “multicolor imaging” as used herein refers to an imaging technique in which information (e.g., a signal, e.g., reflected or emitted light) is obtained or acquired from different sources (e.g., reflective structures, fluorophores or dyes) having different electromagnetic and/or photophysical properties (e.g., colours, i.e., reflected or emitted light properties, wavelengths).

The term “sample location” as used herein refers to any location configured to receive (e.g., sample holder or sample container), comprising or consisting of: any sample suitable for imaging as described herein, e.g., a biological-, non-biological, organic-, non-organic-, naturally occurring- or synthesized sample, or compound, molecule or chemical composition. In preferred non-limiting embodiments, the sample location of the present invention is a biological sample location, which is configured to receive, comprising or consisting of a biological sample.

The term “biological sample” as used herein refers to any living (e.g., in vitro, in vivo or ex vivo) or non-living sample (e.g., post-mostem, frozen or histologically fixed sample, e.g., heat fixed, immersed and/or perfused or chemically fixed, e.g., with an aldehyde, alcohol, oxidizing agent, mercurial, picrate or Hepes-glutamic acid buffer-mediated organic solvent) of at least partial biological origin (e.g., a cell, tissue, organ, whole body, biocomposite, a biomolecule, a composition or mixtures thereof) and includes any biological sample directly or indirectly, fully or partially (e.g., biocomposite) derived from a cell, cell culture, tissue, organ or organism. In preferred non-limiting embodiments, a biological sample of the present invention is e.g., a cell, tissue, cell culture, clinical sample (e.g., a biopsy, bodily fluid, total body water, amniotic fluid, pleural fluid, peritoneal fluid, venipuncture, radial artery puncture, intracellular fluid (ICF), extracellular fluid (ECF), blood, serum, saliva, excreta (e.g., feces or urine), sperm, semen, lymphatic fluid, interstitial fluid, intravascular fluid, transcellular fluid, cerebrospinal fluid (CSF), body tissue, tissue fluid or post-mortem sample), subject (e.g., a mammalian subject, e.g., human), specimen (e.g., a model organism, e.g., a rodent, e.g., Mus musculus or Rattus norvegicus), biocomposite (e.g., comprising a tissue scaffold and at least a cell) and/or mixture/s thereof, e.g., a cell (e.g., in vivo, ex vivo or in vitro cell), a cell culture, a tissue (in vivo, ex vivo or in vitro tissue), a graft (e.g., an autograft, isograft, allograft or xenograft), an organ, an animal or whole body or a fragment/s or portion/s thereof).

The term “model organism” as used herein refers to any non-human species studied to understand any particular biological phenomena. In preferred non-limiting embodiments, the model organism of the present invention is selected from the group consisting of: a virus (e.g., phage lambda, Phi X 174, SV40, T4 phage, Tobacco mosaic virus, Herpes simplex virus), prokaryote (e.g., Escherichia coli Bacillus subtilis, Caulobacter crescentus, Mycoplasma genitalium, Aliivibrio fischeri, Synechocystis, Pseudomonas fluorescens, Azotobacter vinelandii, Streptomyces coelicolor), eukaryote, protist (e.g., Chlamydomonas reinhardtii, Stentor coeruleus, Dictyostelium discoideum, Tetrahymena thermophila, Emiliania huxleyi, Thalassiosira pseudonana), fungus (e.g., Ashbya gossypii, Aspergillus nidulans, Coprinus cinereus, Cryptococcus neoformans, Neurospora crassa, Saccharomyces cerevisiae, Schizophyllum commune, Schizosaccharomyces pombe, Ustilago maydis), plant (e.g., Arabidopsis thaliana), animals, invertebrates (e.g., Aplysia, Drosophila, e.g., Drosophila melanogaster, Hydra), vertebrate (e.g., Gallus gallus, Mesocricetus auratus, Cavia porcellus, Medaka (Oryzias latipes, or Japanese ricefish), Mus musculus, Rattus norvegicus, Xenopus tropicalis and Xenopus laevis, Danio rerio, pigs (e.g., species of genus Sus, e.g., S. scrofa), sheep (e.g., species of genus Ovis, e.g., O. aries), dogs (e.g., species of genus Canis, e.g., Canis lupus familiaris), cats (e.g., species of genus Felis, e.g., F. catus), rabbits (e.g., species of genera Sylvilagus and Oryctolagus, e.g., Sylvilagus floridanus, Oryctolagus cuniculus), cows (e.g., species of genus Bos, e.g., B. taurus) and hourses (e.g., species of genus Equus, e.g., Equus ferus caballus). In preferred embodiments cows and/or horses are model organisms in the sense of the present invention, on which the invention could be used for optical guidance during surgery (e.g., pigs, sheep, cows and/or horses are suitable model organisms for optical guidance during surgery).

### Embodiments of the Present Invention

Imaging off-peak in the SWIR window (an embodiment of the present invention): Current in vivo imaging technologies fail to provide high resolution, desirable penetration depths, and sensitivity simultaneously, which limits their widespread adoption for identifying diseases. For example, high resolution and high sensitivity imaging is straightforward on single cells using visible light imaging techniques. However, when imaging whole animals and their tissues, resolution and sensitivity of subsurface tissue features are drastically reduced due to scattering and absorption of light by surrounding tissue. Another major limitation of conventional in vivo imaging technology is the intense background autofluorescence of tissue at the same wavelengths as the emission wavelengths of the fluorescent probes used to detect various conditions. This overlap of autofluorescence with the expected emission wavelengths of the associated fluorescent probes inhibits disease detection. In one such example, traditional imaging with visible and near infrared wavelengths suffers from poor contrast against the background autofluorescence signals from normal cells and tissues (1). System includes a fluorescent probe with a fluorescence peak below 900 nm and at least a portion of a tail of the fluorescence spectrum at a wavelength greater than 900 nm (1). The inventors have recognized the benefits associated with imaging in the short-wave infrared (SWIR) spectral region to avoid the shortcomings of imaging in the visible and near infrared spectrums. Without wishing to be bound by theory, the longer imaging wavelength reduces photon scattering processes, thus maximizing transmission of the imaged light through the tissue within the SWIR spectrum. Thus, imaging in this frequency range results in significantly improved resolution and signal intensity for a given penetration depth. In addition, SWIR radiation exhibits sufficient tissue penetration depths to noninvasively interrogate changes in subsurface tissue features, whereas visible imaging techniques are typically limited to imaging superficial biological structures. For example, in some embodiments, SWIR may permit penetration depths of up to 2 mm or more with a sub 10 micrometer resolution, though instances where SWIR permits larger penetration depths with a different resolution are also contemplated. Further, unlike the visible and near-infrared regions, the SWIR regime contains very little background autofluorescence from healthy tissues, especially in skin and muscle. This reduced autofluorescence signal improves the contrast with the corresponding fluorescence signal from a fluorescent probe and/or autofluorescence from diseased tissue enabling easier distinction between pathological and non-pathological biological structures. The reduced light scattering, enhanced light transmission, and suppressed background autofluorescence all combine to enable imaging and detection methods with increased contrast, resolution, and sensitivity as compared to more typical imaging methods (1). Fluorescent probes are typically excited in the Visible/Near-Infrared range (e.g., 400-1100 nm), those probes could include fluorescent dyes, quantum dots and carbon nanotubes. The emission spectrum lies as well in the visible/near-infrared range. However, a part of the spectrum is detectable in the short-wave infrared (e.g., 900 nm-2500 nm). This allows the use of the advantages of detection in the short wave. Advantages includes the increased contrast; this contrast comes from the absorption features of water in the infrared regime. Those absorption features at different wavelength bands can be used to extract depth information from images and hence to extract 3D information from the 2D images (2).

Exemplary non-limiting detection (an embodiment of the present invention): Imaging in this wavelength regime has been limited by the detector technologies, still the price of SWIR cameras is high. Available detectors include InGaAs detectors (e.g., 900-1700 nm), HgCdTe or MCT detectors (e.g., 700-2500 nm), Germanium, bolometers, superconducting nanowires, pyroelectric detectors etc. The cameras are cooled and have a certain level of read noise (noise of the electronics of camera, level is much higher compared to conventional silicon based CMOS detectors) and dark current/dark noise (noise from detecting photons (or generating charges) not originating from the imaged object but rather the camera system itself), to achieve images with controllable noise levels one has to keep the exposure time minimal, this allows to stay in the noise regime where only the read noise the camera but not the dark current/dark noise influences the detection. By exposing longer, one enters a higher noise level, where the dark current (temperature dependent noise) kicks in. This leads to noisier pictures. Hence, controlling the laser/LED/light source and the camera together allows to keep the noise level minimal. By triggering the laser/LED/light source and sending pulses of excitation light and coupling the detection one achieves better outcome. To have a rather high capture of the emitted light of the probe one needs optimized optics. The lenses are coated for the infrared regime (C-Coating by Thorlabs, e.g., 1050-1700 nm) in order to prevent unwanted reflections from the surfaces. To filter out the excitation light and the emitted light in the visible regime, one adds filters on the detection path. An example would be a 1000 nm or a 1100 nm Long Pass filter, only permitting light of wavelengths above 1000 nm to pass.

Exemplary non-limiting technical specification (an embodiment of the present invention): Exemplary non-limiting functional description (e.g., FIG. 2): Given a biological sample embedded with targeted SWIR probes, the imaging system can be accessed and controlled to attain a real-time multi-color SWIR fluorescence image data via a desktop PC based control station. Probe-specific optimized excitation and emission filters are integrated with the system to achieve high optical sensitivity of target structures. Users may programmatically access the microcontroller of the trigger unit and the detector firmware via control unit. Subsequently, the trigger sequence is uploaded to the trigger unit and detector parameters are assigned to the detector unit. The trigger sequence algorithm then initiates and controls the synchronization of VIS/NIR/SWIR excitation unit and detector unit to achieve real-time multi-color SWIR fluorescence image acquisition. The microcontroller trigger signal interface transmits the electrical signals to the excitation driver unit and produces desired optical signals of excitation. The optical excitation signals enter the biological samples infused with SWIR probes and returns as autofluorescence and fluorescence optical emission signals. The fluorescence optical emission signals are collected using a detector unit and may filtered from the associated autofluorescence signals and other obstructive signals of interference. The detector unit then performs image acquisition of VIS/NIR/SWIR excited biological structures using multiple pixel detector array (e.g., a camera chip). By chemically engineering high intensity fluorescence signals from the targeted infrared probes, the exposure time required for the pixel data acquisition is minimized and high frame-rate acquisition is enabled. Consequently, a fast frame-rate acquisition detector device is employed to enable image acquisition. A temporally separated and fast switched excitation source with multiple electromagnetic excitation wavelengths and low-transient is electronically controlled to achieve simultaneous switching of detector device and excitation wavelengths of interest. Thus, a high through-put multi-spectrum pixel image dataset is generated in the short-wave infrared electromagnetic spectrum (e.g., 900 nm-2500 nm). This image data is displayed during the signal acquisition and stored in the control unit. The acquired multi-spectrum image dataset is then processed in the control unit to produce multicolor real-time image data that is analogues to the SWIR electromagnetic spectrum.

Exemplary non-limiting system architecture (an embodiment of the present invention): As shown in the FIG. 2, the functional imaging system comprises a control unit, a trigger unit, an excitation unit, a transmission unit, a detection unit and a safety enclosure. The technical features and functions of the individual system components are detailed as follows.

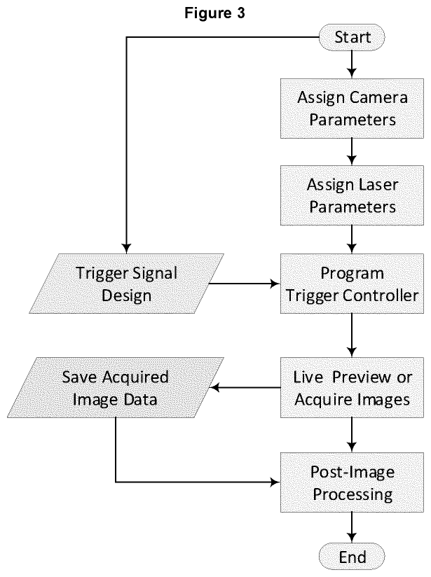

Exemplary non-limiting control unit (an embodiment of the present invention): The control unit enables the system users to electronically access and control other functional components of the system. The control unit may consist of a data acquisition unit (DAU), electronic processors (Processor), electronic memory unit (Memory), electronic input-output modules (I/O), display units (Display). The sub-system components of the control unit work together to execute the application specific machine instructions. The general description of application specific algorithm is presented in FIG. 3 herein. As observed the sequential execution of this flowchart is carried-out by automatic or manual means in the control unit. The implemented algorithm in FIG. 3 features a sequential time-driven implementation strategy to achieve high-throughput multicolor imaging system. An alternative imaging system development is to use a model-based event-driven strategy to realize the same outcome. In the model-based event-driven algorithm, the experiment or application specific trigger signal is modelled and simulated prior to the execution in the microcontroller. Further, the feedback information from the event-driven closed-loop control structure would eliminate the inter-delays during the system operation. The DAU is a digital device that employs a high-bandwidth data path using digital communication protocols between the detector unit and the memory of the control unit. It facilitates the high through-put transfer of acquired image data with low latency to the control unit for subsequent image processing. As such a DAU can be any semiconductor-based device that includes its own sub-system components such as digital processors, controllers, field-programmable transistor circuitries and its own set of machine instructions and communication protocols. The processor unit may be implemented as integrated circuits, with multiple processors in an integrated circuit component, including commercially available integrated circuit components such as CPU chips, GPU chips, microprocessors, co-processors or an ASIC, or semicustom circuitry from a programmable logic device (1). The components of the control unit can be a single computing device embodied in variety of forms. This may include rack-mounted computer, a desktop computer, a laptop computer, a tablet computer, a smart phone, a personal digital assistant or any other suitable portable or fixed electronic device (1). In this aspect, a computing device may have one or more input and output devices (1/O) that may be used to present a user interface and interconnected by one or more networks in any suitable form, including as a local area network or a wide area network, such as an enterprise network or the Internet (1). The various implementation methods or processes for the design of the control unit may be coded as software components that is executable on one or more processors and can be written in suitable programming languages and/or programming or scripting tools, and also may be compiled as executable machine language code or intermediate code that is executed on a framework or virtual machine (1). Additionally, the control unit can also be integrated with internet of things (IoT) devices and cloud-based computing algorithms for the remote operation of the imaging system. As such, the control unit can also be a virtual machine interface that enables user interaction with the other components of the imaging system.

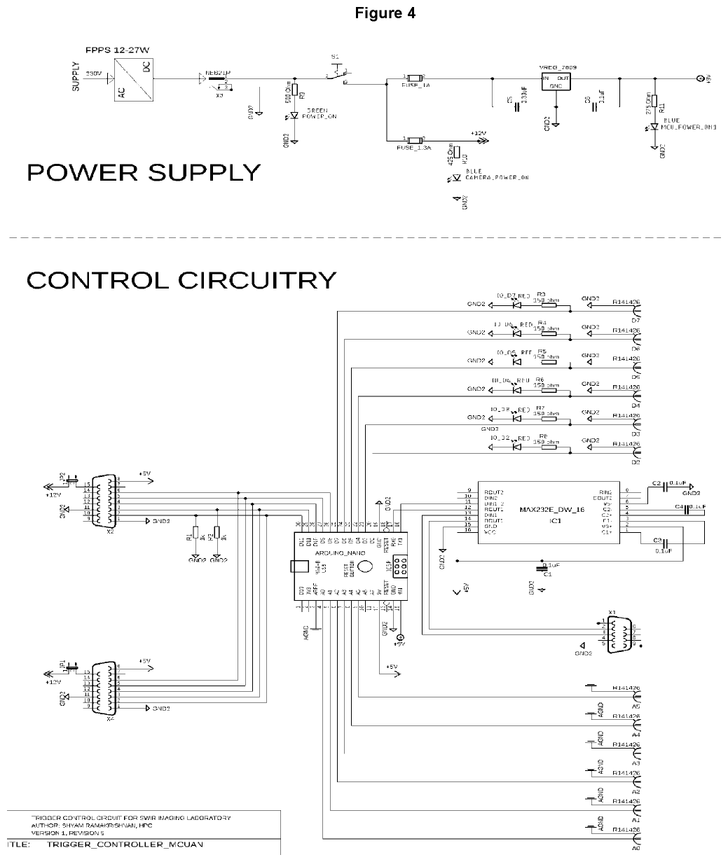

Exemplary non-limiting trigger unit (an embodiment of the present invention): The trigger unit receives user instructions from control unit for high-speed switching control of detection unit and excitation unit by generating electrical signals of interest. It consists of a microcontroller, trigger signal interface, communication interface and a power supply unit. An example implementation of a microcontroller-based trigger unit is illustrated in FIG. 4 herein by means of an electrical schematic diagram. The application specific control instructions can be designed in the control unit and programmed in the trigger unit microcontroller via the communication interface. The dedicated power supply for the trigger controller enables the stand-alone operation of the trigger unit independent of the control unit. Therefore, with appropriately programmed microcontroller, the trigger unit retains the control of excitation and detection units and facilitates the sequential transduce of electrical-optical-electrical signals. The utilized microcontroller unit is a 32 bit, 16 MHz off-the shelf microcontroller board. It features 32 KB (2 KB reserved for the bootloader) of flash memory, 1 KB of EEPROM and a SRAM of 2 KB. It features 22 digital 1/O pins (of which 11 pins are effectively used in the trigger unit) and 6 Analog input pins. The operating voltage of the microcontroller is 5V and each digital pins require 40 mA of DC current. The high frequency operation of the microcontroller yields a delay and transient free operation of the trigger unit in the time resolutions low as ˜1 ms. The microcontroller unit can be any semiconductor based electronic sub-system that may facilitate analog and digital signal processing, programming and data memory, digital and analog input-output periphery, crystal oscillators for clock signal generation, analog to digital conversion units (ADU), digital to analog conversion units (DAU) and communication interfaces. The microcontroller unit may share the features and functions of the processor subsystem of the control unit but shall be completely independent of the control unit. As such, independent control units can also be employed to access and configure the trigger unit and the detector units to constitute a functional system architecture in contrast to the system proposed in (1). The trigger signal interface constitutes electric signal coupling between the microcontroller unit and external peripheries such as excitation and detector control systems. Depending on the system design strategy the excitation and detector control systems can be designed as independent sub-systems or embedded sub-systems in the trigger unit. The signal interface can consist of electrical cabling or wireless electrical communication devices. The trigger signal interface facilitates bi-directional flow of signals to and from the devices or sub-systems of interest. The communication interface facilitates the access of trigger unit from a control unit. It informs the status of the connected sub-system components to the control unit and enables the user-access to the programmable microcontroller sub-system. The power supply sub-system of the control unit is designed to supply the operational power requirements of the trigger unit and upon requirement the detector unit.

Exemplary non-limiting excitation unit (an embodiment of the present invention): The excitation unit transduces the electrical signals to the VIS/NIR/SWIR optical signals in single spectrum or in multiple spectra. It consists of a controlled light source, a driver unit and a power supply. Any appropriate excitation source may be used including, but not limited to, a diode laser, light emitting diode, or any other appropriate source of electromagnetic radiation within a desired spectral band (1). The excitation sources are optically coupled to the transmission unit via an appropriate optical coupling such as optical fiber bundles, a light pipe, a planar light guide or an optically clear space (1). The driver unit sub-system of the excitation unit converts the incoming voltage-coded electrical signals into desired power levels of the excitation source. Doing so, it extracts electrical power from the power supply sub-system of the excitation unit and controls the optical power of the excitation source. Depending on the application requirement, the driver unit may provide a constant power output, an external digital modulated power output, an external analog modulated power output or an internal digital modulated power output. In case of external digital modulated power output mode, the switching states of the excitation source is controlled by the electrical signals generated by the trigger unit. Thus, generating the optical signals of interest following the received electrical signals. Depending on the application requirements one or more light sources of varying spectrum can be employed to achieve multicolor image acquisition.

Exemplary non-limiting transmission unit (an embodiment of the present invention): The transmission unit optically couples the excitation unit and the safety enclosure where the biological sample is being placed. It consists of optical coupling mechanism, excitation filters and a diffuser. The optical coupling routes the electromagnetic radiation from the excitation source to excitation filters (1). For a given application, a desired set of excitation wavelengths can be optically transmitted to the biological samples consisting of SWIR probes. The excitation filters are a combination of low and/or high and/or bandpass and/or laser-line filters to provide electromagnetic radiations of predetermined electromagnetic spectra. The filters may exclude electromagnetic wavelengths above and/or below a desired fluorescence spectrum wavelength or other undesirable excitation wavelengths (1). The transmitted electromagnetic radiation may then pass through an engineered diffuser to evenly spread the excitation light across the biological sample of interest. Depending on the application needs, the transmission unit can be designed individually for each excitation source or designed as a single unit for all excitation sources of varying electromagnetic spectra.

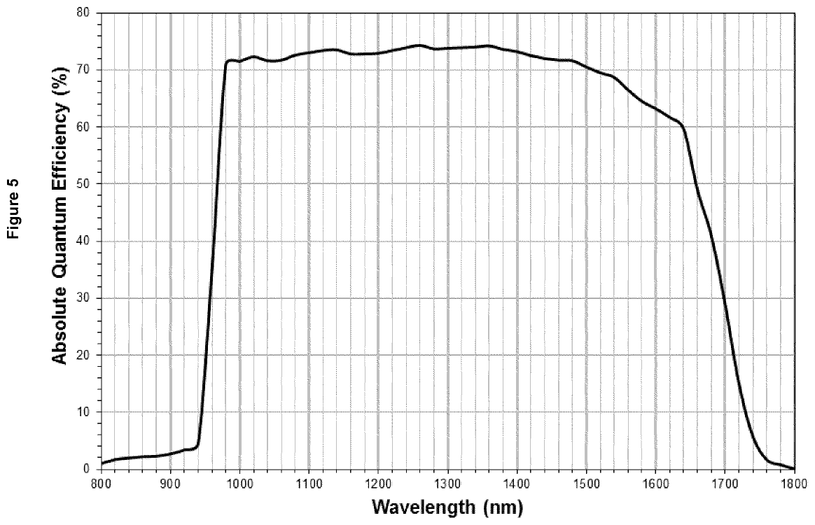

Exemplary non-limiting detection unit (an embodiment of the present invention): The detection unit partly collects the optical signals generated by the SWIR fluorescent probe within the biological sample and transduces them into electrical signals. It consists of a detector, emission filters and an objective. The detector is made of plurality of pixels and with appropriately configured and arranged objective, it collects optical signals from the emitting electromagnetic radiations of SWIR fluorophores (1). The detector may be sensitive to any appropriate range of electromagnetic wavelengths including the short-wave infrared spectral range (1). In addition, the used detector shall facilitate high frequency image acquisition to facilitate multicolor real-time imaging. The detector shall also accompany an input-output interface to facilitate external control with voltage-coded electrical signals. One or more filters may be placed in between the detector and biological sample with SWIR fluoresces to reject reflected excitation light and other optical interferences that may impair the acquisition of signals of interest (1). The detector used in the system is an Allied Vision Goldeye G032 Cool camera. The technical specifications for the camera are shown in the Table 1 and its quantum efficiency is reported in FIG. 5.

TABLE 1
Camera Specifications for Goldeye G032 cool.

| | |
|---|---|
| Sensor Type | InGaAs FPA |
| Pixel size | 25 μm × 25 μm |
| Resolution | 636 (H) × 508 (V) |
| ADC | 14 Bit |
| Max. frame rate at full resolution | 100 fps |
| Temporal dark noise | 400 e⁻ (Gain0), 170 e⁻ (Gain1) |
| Saturation capacity | 1.9 Me⁻ (Gain0), 39 ke⁻ (Gain1) |
| Dynamic range | 73 dB (Gain0), 47 dB (Gain1) |

Upon detecting a fluorescent signals and/or auto-fluorescent signals, the detector may output the analogous electrical signals to a processor subsystem of the control unit. The processor may then appropriately process the information as stated earlier to determine whether the detected signal corresponds to a targeted biological structure and/or state (1). This information may be determined for each pixel either for a single captured image and/or continuously in real time and may be displayed as an image on a display and/or stored within a memory of the control unit. By multiplexing different biological targets with variety of SWIR fluorophores, the processing unit can be used to isolate and render multicolor real-time image information.

Exemplary non-limiting safety enclosure (an embodiment of the present invention): The safety enclosure of the system reiterates the safety of the user whilst blocking optical interference to the detector unit. It may be designed as a physical component matching the dimension of the imaging system with materials that block optical signals. An enclosure may also facilitate the mounting mechanisms to hold the system and sub-system components of the imaging system.

Exemplary non-limiting system specification (an embodiment of the present invention).

TABLE 2
Exemplary non-limiting system specification

| | |
|---|---|
| Detection Range | 1000-1600 nm |
| Absolute Quantum Efficiency | Up to 70% |
| Detection Resolution | 636 (H) × 508 (V) |
| Detection Speed | 100 FPS (can be extended to 300 FPS |
| | with Goldeye CL 033 Camera) |
| Excitation | Up to 25 W optical illumination in the |
| | wavelengths of 785 nm, 892 nm, |
| | 980 nm, 1062 nm |
| Triger-time resolution | 1 ms |
| Trigger-time delay | Less than 10 uS |
| Image Color Rendering | 4 Color (Can be extended to 5 and |
| | more colors) |
| No. of Detector Control Ports | 2 |
| No. of Excitation Control Ports | 6 |
| No. of Analog Input Ports | 6 |
| Optical System | Adaptable and reconfigurable SWIR |
| | optical system |

In some aspects, the system of the present invention has the specification and/or functionality as described in Table 2.

In some aspects, the system of the present invention has the specification and/or functionality as described in FIG. 1.

In some aspects, the system of the present invention has the specification and/or functionality as described in FIG. 2.

In some aspects, the system and method of the present invention employing high-power excitation sources in combination with state of the art InGaAs SWIR detectors (e.g., HgCdTe or MCT, Germanium, superconducting nanowires, PbS sensitized silicon chips, bolometers, schottky barrier and pyroelectric detectors; or any other detector technology sensitive between 1000 and 2500 nm) and SWIR illuminated fluorophores (e.g., FIGS. 1 and 2).

In some aspects, the systems and methods of the present invention are capable of synchronizing the emission of light sources and SWIR detectors and acquire image data faster than the detectable movements of biological systems.

In some aspects, the sequentially triggered excitation sources of the present invention illuminate their corresponding fluorophores in the biological sample and detected by synchronized InGaAs detectors to achieve a multi-color SWIR imaging system.

In some aspects, the synchronized emitter-detector imaging system of the present invention also enables high-dynamic range (HDR) imaging and fluid flow-velocimetry mapping of biological structures in SWIR spectrum.

In some aspects, the system and method of the present invention provide the following exemplary functionality (e.g., FIGS. 1 and 2). Given a biological sample embedded with targeted SWIR probes, the system can be accessed and controlled to attain a real-time multi-color SWIR fluorescence image data. Probe-specific optimized excitation and emission filters are designed and integrated with the system to achieve high optical sensitivity of target structures. User via control unit programmatically accesses the microcontroller of the trigger unit and the detector. Subsequently, the trigger sequence is uploaded to the trigger unit and detector parameters are assigned to the detector unit. The trigger sequence algorithm then initiates and controls the synchronization of VIS/NIR/SWIR excitation unit and detector unit to achieve real-time multi-color SWIR fluorescence image acquisition. The microcontroller trigger signal interface transmits the electrical signals to the excitation driver unit and detector to perform image acquisition of VIS/NIR/SWIR excited biological structures. The high-through put design of the system can operate in higher frequencies than detectable motion of the biological structures. Thus, achieving an in vivo real-time multi-color SWIR fluorescence image acquisition system.

In some aspects, the system/method of the present invention comprising/providing one or more of the following: a control unit (e.g., an exemplary control unit as described herein), a trigger unit (e.g., an exemplary trigger unit as described herein), an excitation unit (e.g., an excitation unit as described herein), a transmission unit (e.g., an exemplary transmission unit as described herein), a detection unit (e.g., an exemplary detection unit as described herein) and safety enclosure (e.g., an exemplary safety enclosure as described herein).

In some aspects, the system/method of the present invention comprising/providing a sample location (e.g., a biological sample location, configured to receive, comprising or consisting of: a biological sample (e.g., a cell, tissue or cell culture), a clinical sample (e.g., a biopsy, bodily fluid, total body water, amniotic fluid, pleural fluid, peritoneal fluid, venipuncture, radial artery puncture, intracellular fluid (ICF), extracellular fluid (ECF), blood, serum, saliva, excreta (e.g., feces or urine), sperm, semen, lymphatic fluid, interstitial fluid, intravascular fluid, transcellular fluid, cerebrospinal fluid (CSF), body tissue, tissue fluid or post-mortem sample), a subject (e.g., a mammalian subject, e.g., human), a specimen (e.g., a model organism, e.g., a rodent, e.g., Mus musculus or Rattus norvegicus), a biocomposite (e.g., comprising a tissue scaffold) and/or mixture/s thereof, e.g., a cell (e.g., in vivo, ex vivo or in vitro cell), a cell culture, a tissue (in vivo, ex vivo or in vitro tissue), a graft (e.g., an autograft, isograft, allograft or xenograft), an organ, an animal or whole body or a fragment/s or portion/s thereof).

In some aspects, the system/method of the present invention is non-invasive.

In some aspects, the system/method of the present invention are used in one or more of the following applications: Multicolor Real-time Image Acquisition (e.g., in SWIR, e.g., as described in the examples section herein); High-dynamic Range Image Acquisition (e.g., in SWIR, e.g., as described in the examples section herein); Dark-current Noise-less imaging (e.g., in SWIR, e.g., as described in the examples section herein); Three-dimensional Imaging (e.g., in SWIR, e.g., as described in the examples section herein); Strobo-Effected Image Acquisition (e.g., in SWIR, e.g., as described in the examples section herein); Emission & Excitation Fingerprint (e.g., as described in the examples section herein)

In some aspects, the system/method of the present invention are provided according to FIG. 1 and/or FIG. 2 and/or Table 1 and/or Table 2 and/or exemplary non-limiting specifications/functionalities as described herein above.

In some aspects, the present invention provides novel SWIR targeted fluorophores, preferably flavylium heptamethine fluorophores/dyes, e.g., as described in the examples section herein below, e.g., Julo7 (or elsewhere, e.g., as in WO 2018/226720 A1).

In some aspects, the present invention provides synthesis of novel SWIR targeted fluorophores, e.g., flavylium heptamethine fluorophores/dyes, e.g., as described in the examples section herein below, e.g., Julo7 (or elsewhere, e.g., WO 2018/226720 A1).

In some aspects, the present invention provides novel SWIR targeted fluorophores, e.g., flavylium heptamethine fluorophores/dyes, e.g., as described in the examples section herein below, e.g., Julo7 synthesised as described in the examples section herein below (or elsewhere, e.g., WO 2018/226720 A1.

In some aspects, the present invention provides SWIR targeted fluorophores, preferably flavylium heptamethine fluorophores/dyes, e.g., ICG and/or Julo7 for use in methods/systems of the present invention.

In some aspects, the systems/methods of the present invention utilize indocyanine green (ICG) fluorophore:

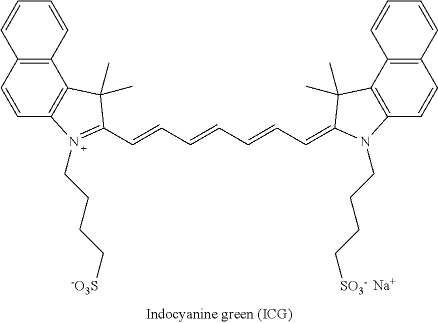

In some aspects, the systems/methods of the present invention utilize Julo7 fluorophore, a red-shifted by ˜35 nm (compared to Flav7 fluorophore) julolidine derivative with absorption at 1061 nm and emission at 1088 nm):

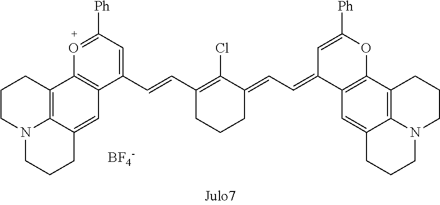

Compared to existing imaging systems and methods the systems and methods for real-time multicolor shortwave infrared fluorescence imaging of present invention inter alia offer the following advantages that are aspects of the present invention:
Wide range of high-power fiber-coupled light sources and targeted SWIR probes for multicolor imaging;
Highly scalable, user controllable and synchronized emitter-detector system for in vivo biomedical imaging;
High-dynamic range imaging of biological structures in SWIR;
High throughput detector and microcontroller based sequential trigger for real-time multicolor imaging in SWIR spectrum;
Synchronizing the emission of light sources and SWIR detectors and acquiring image data faster than the detectable movements of biological systems;
The synchronized emitter-detector imaging system also enabling high-dynamic range (HDR) imaging and fluid flow-velocimetry mapping of biological structures in SWIR spectrum.
Full control over excitation and detection enabling multiple applications;
Imaging in the SWIR region benefiting from less scattering, autofluorescence, etc.
Possibility to image off-peak, emission signal of fluorophores sufficient off-peak;
Multi-color real-time imaging in the SWIR;
Compatible with Matlab and Simulink programming environments;
16 MHz 32 bit AVR Microcontroller based trigger unit;
Flexible and reconfigurable optical system;
Not limited to fluorescence imaging; can be used in reflection imaging without fluorophores;
The system can be implemented in an event driven control algorithm to increase the time resolution and improve the inter-delays without modifying the hardware of the system.
The system can integrate high-performance SWIR detector with minimal modification to the existing hardware and software.
The time-resolution of the system can be greatly reduced by incorporating higher frequency, off-the-shelf microcontrollers. The existing trigger unit will be redesigned to accommodate faster system performance bringing the system time resolution in the order of few nanoseconds. In such instance, there is also potential to expand the number of controllable peripherals (light sources and detectors).
The time-delays of the system can be further reduced by re-designing the trigger controller as mentioned above and incorporating faster excitation side light source drivers/controllers
Non-invasive imaging
Reduction of melanin absorption in the SWIR (e.g., in/for in vivo imaging methods, e.g., in genetically-labelled or transgenic model organisms, e.g., mice); Melanin is a hurdle for conventional florescence imaging in VIS/NIR range because black melanin spots on the skin absorb emission signal from deeper structures; This absorption is much weaker in the SWIR range; A majority of commercial genetically-modified mice have strong melanin presence due to their genetic background; imaging in the SWIR range allows any mouse to be used regardless of genetic background;
SWIR imaging according to/with methods and/or systems of the present invention is a solution for a non-invasive imaging of tissues and organisms (e.g., with or without markers such as fluorescent dyes) in the presence of melanin.

The invention is also characterized by the following items:
1. A method for multiplexed and/or multicolor imaging of a sample location (e.g., a biological sample location, configured to receive, comprising or consisting of: a biological sample (e.g., a cell, tissue or cell culture), a clinical sample (e.g., a biopsy, bodily fluid, total body water, amniotic fluid, pleural fluid, peritoneal fluid, venipuncture, radial artery puncture, intracellular fluid (ICF), extracellular fluid (ECF), blood, serum, saliva, excreta (e.g., feces or urine), sperm, semen, lymphatic fluid, interstitial fluid, intravascular fluid, transcellular fluid, cerebrospinal fluid (CSF), body tissue, tissue fluid or post-mortem sample), a subject (e.g., a mammalian subject, e.g., human), a specimen (e.g., a model organism, e.g., a rodent, e.g., Mus musculus or Rattus norvegicus), a biocomposite (e.g., comprising a tissue scaffold) and/or mixture/s thereof, e.g., a cell (e.g., in vivo, ex vivo or in vitro cell), a cell culture, a tissue (in vivo, ex vivo or in vitro tissue), a graft (e.g., an autograft, isograft, allograft or xenograft), an organ, an animal or whole body or a fragment/s or portion/s thereof), said method comprising:
   i) exposing a portion of said sample location to a first light pulse/s (e.g., an excitation light pulse/s), wherein said first light pulse/s having:
      (a) a first state (e.g., said state has one or more of the properties of a wavelength and/or spectrum; e.g., linear, circular and elliptical polarization, intensity, incident angle and pulse length); or
      (b) a first wavelength;
      in order to illuminate (e.g., for reflectance imaging) or excite a first component (e.g., fluorescent component, e.g., VIS/NIR/SWIR fluorophores, preferably polymethine fluorophores/dyes, e.g., ICG, IRDye800CW, Julo5 and/or Julo7, e.g., WO 2018/226720A1, or autofluorescent tissue component, e.g. pigments, preferably lipofuscin), chemical composition, surface and/or region in the portion of said sample location (e.g., a first dye comprised by the portion of said sample location);
   ii) exposing the portion of said sample location to at least a second light pulse/s (e.g., a second excitation light pulse/s) having:
      (c) a second state (e.g., said state has one or more of the properties of a wavelength and/or spectrum; e.g., linear, circular and elliptical polarization, intensity, incident angle and pulse length), which is different from the first state of (a); or
      (d) a second wavelength, which is different from the first wavelength of (b);
      in order to illuminate (e.g., for reflectance imaging) or excite a second component (e.g., fluorescent component, e.g., VIS/NIR/SWIR fluorophores, preferably polymethine fluorophores/dyes, e.g., ICG, IRDye800CW, Julo5 and/or Julo7, e.g., WO 2018/226720A1, or autofluorescent tissue component, e.g. pigments, preferably lipofuscin), chemical composition, surface and/or region in the portion of said sample location (e.g., a second dye comprised by the portion of said sample location), preferably said second component, chemical composition, surface or region is different from said first component, chemical composition, surface or region;
   wherein the first light pulse/s (e.g., the first excitation light pulse/s) and the second (and/or subsequent) light pulse/s (e.g. the second excitation light pulse/s) are provided sequentially or alternately;
   iii) detecting light reflected or emitted by the first and the second component (e.g., fluorescent components or dyes), chemical composition, surface and/or region in the portion of said sample location (e.g., the first and the second fluorescent components or dyes) by an imaging device, wherein the peak emission wavelength of at least one component, chemical composition, surface and/or region in the portion of said sample location lies outside of the detection range of the imaging device, the detection process including:
      aa) switching the imaging device, in a sequential or an alternating manner, between a first configuration (or state) during which the imaging device is responsive to a first electromagnetic radiation and a second configuration (or state) during which the imaging device is:
         i′) responsive to a second electromagnetic radiation (e.g., said first and second electromagnetic radiations are not identical); or
         ii′) unresponsive to electromagnetic radiation, wherein the switching of the first configuration (or state) is triggered by the provision of the light pulse/s (e.g., by the means of provision of electrical pulses to the light sources).
2. The method according to any one of preceding items, said method comprising:
   i) exposing a portion of said sample location to a first light pulse (e.g., an excitation light pulse), wherein said first light pulse having a first wavelength; in order to illuminate (e.g., for reflectance imaging) or excite a first dye comprised by the portion of said sample location);
   ii) exposing the portion of said sample location to at least a second light pulse (e.g., a second excitation light pulse) having a second wavelength, which is different from the first wavelength; in order to illuminate (e.g., for reflectance imaging) or excite a second dye comprised by the portion of said sample location);
   wherein the first light pulse (e.g., the first excitation light pulse) and the second light pulse (e.g. the second excitation light pulse) are provided sequentially or alternately;
   iii) detecting light reflected or emitted by the first and second component, chemical composition, surface and/or region in the portion of said sample location (e.g., the first dye and the second dye) by an imaging device, wherein the peak emission wavelength of at least one component, chemical composition, surface and/or region in the portion of said sample location lies outside of the detection range of the imaging device, the detection process including:
      aa) switching the imaging device, in a sequential or alternating manner, between a first configuration (or state) during which the imaging device is responsive to a first electromagnetic radiation and a second configuration (or state) during which the imaging device is responsive to a second electromagnetic radiation (e.g., said first and said second electromagnetic radiations are not identical), wherein the switching of the first configuration is triggered by the provision of the light pulse (e.g., by the means of provision of electrical pulses to the light sources).
3. The method according to any one of preceding items, further comprising: providing an optical filter in the optical path between the portion of said sample location and the imaging device, the optical filter being configured to block the first excitation light and the second excitation light.
4. The method according to any one of preceding items, wherein the optical filter is configured as a longpass or bandpass filter with a cut-on wavelength in the micrometer range.
5. The method according to any one of preceding items, wherein the detection range of the imaging device lies in the micrometer range, preferably in the short-wave infrared (SWIR) range.
6. The method according to any one of preceding items, wherein the first and the second excitation light pulses are provided at the same rate or at the different rate.
7. The method according to any one of preceding items, wherein the pulse length of the first and second excitation light pulses is: i) 10 ms or shorter; ii) up to several (e.g., 1, 2, 3, 4, 5, 6, 7, 8, 9, or 10) seconds; or iii) up to several (e.g., 1, 2, 3, 4, 5, 6, 7, 8, 9, or 10) minutes.
8. The method according to any one of preceding items, wherein the duty cycle of the first and second pulses is: i) 1% or less; or ii) up to 100%.
9. The method according to any one of preceding items, wherein the first excitation light pulse/s and the second excitation light pulse/s impinge on the portion of said sample location from the same spatial direction.
10. The method according to any one of preceding items, wherein the first excitation light pulse/s and the second excitation light pulse/s impinge on the portion of said sample location from different spatial directions.
11. The method according to any one of preceding items, as long as dependent on item 4, wherein the peak emission wavelength of at least one of the dyes lies below the cut-on wavelength of the longpass filter.
12. The method according to any one of preceding items, wherein for any wavelength within the detection range of the imaging device the emission intensity of at least one of the dyes amounts to: i) 1% or less, preferably to 0.1% or less, of the peak emission intensity of the respective dye; ii) 30% or less of the peak emission intensity of the respective dye; iii) up to 100% of the peak emission intensity of the respective dye; or iv) in the range between 30%-100% of the peak emission intensity of the respective dye.
13. The method according to any one of preceding items, wherein the switching of the device into the first configuration (or state) is triggered by the provision of the light pulse/s such that the imaging device is switched into the first configuration (or state) simultaneously with or within 2 microseconds after the emission of any one of the first and second excitation light pulse/s.
14. The method according to any one of preceding items, wherein said method does not comprise a moving and/or switching an optical filter or optical filter array.
15. The method according to any one of preceding items, wherein said method comprising providing only one optical filter.
16. The method according to any one of preceding items, wherein said method comprising providing a high-power excitation source in combination with an InGaAs SWIR detectors and VIS/NIR/SWIR illuminated fluorophores (e.g., polymethine dyes, e.g., as described in examples section herein).
17. The method according to any one of preceding items, wherein said method is one or more of the following methods:
   i) an in vivo, ex vivo and/or in vitro method (e.g., a non-invasive method);
   ii) a diagnostic, therapeutic, surgical (e.g., intraoperative imaging, fluorescence guided surgery) and/or screening method (e.g., management and treatment of voice disorders);
   iii) a tissue engineering and/or transplantation method;
   iv) a three-dimensional (3D) bioprinting method;
   v) a real-time imaging method (e.g., real-time multiplexed imaging in non-transparent animals e.g., as described in the examples section herein);
   vi) a High-Dynamic-Range (HDR) imaging method, preferably HDR imaging method of biological structures in SWIR;
   vii) a fluorescence imaging method;
   viii) a multicolor real-time image acquisition (e.g., in SWIR, e.g., as described in the examples section herein, e.g., Imaging of Awake State, Intestinal Mobility Tracking, Lymphatic Imaging);
   ix) a high-dynamic range image acquisition (e.g., in SWIR, e.g., as described in the examples section herein);
   x) a dark-current noise-less imaging (e.g., in SWIR, e.g., as described in the examples section herein);
   xi) a three-dimensional imaging (e.g., in SWIR, e.g., as described in the examples section herein);
   xii) a strobo-effected image acquisition (e.g., in SWIR, e.g., as described in the examples section herein);
   xiii) an emission and excitation fingerprint (e.g., as described in the examples section herein);
   xiv) a method for reduction of melanin absorption in the SWIR;
   xv) a method for a non-invasive imaging of tissues and/or organisms (e.g., with or without markers such as fluorescent dyes) in the presence of melanin.
18. A system for multiplexed and/or multicolor imaging of a sample location (e.g., a biological sample location, configured to receive, comprising or consisting of: a biological sample (e.g., a cell, tissue or cell culture), a clinical sample (e.g., a biopsy, bodily fluid, total body water, amniotic fluid, pleural fluid, peritoneal fluid, venipuncture, radial artery puncture, intracellular fluid (ICF), extracellular fluid (ECF), blood, serum, saliva, excreta (e.g., feces or urine), sperm, semen, lymphatic fluid, interstitial fluid, intravascular fluid, transcellular fluid, cerebrospinal fluid (CSF), body tissue, tissue fluid or post-mortem sample), a subject (e.g., a mammalian subject, e.g., human), a specimen (e.g., a model organism, e.g., a rodent, e.g., Mus musculus or Rattus norvegicus), a biocomposite (e.g., comprising a tissue scaffold) and/or mixture/s thereof, e.g., a cell (e.g., in vivo, ex vivo or in vitro cell), a cell culture, a tissue (in vivo, ex vivo or in vitro tissue), a graft (e.g., an autograft, isograft, allograft or xenograft), an organ, an animal or whole body or a fragment/s or portion/s thereof), said system comprising:
   i) a first light source (e.g., a laser, LED, lamp or any other suitable light source) configured to operate at a first wavelength;
   ii) at least a second light source (e.g., a laser, LED, lamp or any other suitable light source) configured to operate at a second wavelength;
   iii) an imaging device configured to detect electromagnetic radiation;
   iv) a control unit coupled to the first light source (e.g., a laser, LED, lamp or any other suitable light source), the second light source (e.g., a laser, LED, lamp or any other suitable light source) and the imaging device, wherein the control unit is configured to control the first light source to provide first excitation light pulse/s and to control the second light source to provide second excitation light pulse/s in sequential or an alternating manner; wherein the control unit is further configured to switch the imaging device in a sequential or an alternating manner, between a first state during which the imaging device is responsive to a first electromagnetic radiation and a second state during which the imaging device is
      a) responsive to a second electromagnetic radiation (e.g., said first and second electromagnetic radiations are not identical); or
      b) unresponsive to electromagnetic radiation;
   wherein the system is configured such that the switching of the imaging device into the first state is triggered by the provision of the light pulse/s (e.g., by the means of provision of electrical pulses to the light sources).
19. The system according to any one of preceding items, wherein said system comprises two or more light sources (e.g., lasers, LEDs, lamps or any other suitable light sources), preferably said light sources are configured to be operated (e.g., be switched on) simultaneously during pulses (e.g., definable, e.g., operator-definable or certain, pulses).
20. The system according to any one of preceding items, further comprising: an optical filter in the optical path between the portion of said sample location and the imaging device, the optical filter being configured to block the first excitation light and the second excitation light.
21. The system according to any one of preceding items, wherein the optical filter is configured as a longpass or bandpass filter with a cut-on wavelength in the micrometer range.
22. The system according to any one of preceding items, wherein the detection range of the imaging device lies in the micrometer range, preferably in the short-wave infrared (SWIR) range.
23. The system according to any one of preceding items, wherein the first and the second excitation light pulses are provided at the same rate or at the different rate.
24. The system according to any one of preceding items, wherein the pulse length of the first and second excitation light pulses is: i) 10 ms or shorter; ii) up to several (e.g., 1, 2, 3, 4, 5, 6, 7, 8, 9, or 10) seconds; or iii) up to several (e.g., 1, 2, 3, 4, 5, 6, 7, 8, 9, or 10) minutes.
25. The system according to any one of preceding items, wherein the duty cycle of the first and second pulses is: i) 1% or less; or ii) up to 100%.
26. The system according to any one of preceding items, wherein the first excitation light pulse/s and the second excitation light pulse/s impinge on the portion of said sample location from the same spatial direction.
27. The system according to any one of preceding items, wherein the first excitation light pulse/s and the second excitation light pulse/s impinge on the portion of said sample location from different spatial directions.
28. The system according to any one of preceding items, as long as dependent on item 20, wherein the peak emission wavelength of at least one of the dyes lies below the cut-on wavelength of the longpass filter.
29. The system according to any one of preceding items, wherein for any wavelength within the detection range of the imaging device the emission intensity of at least one of the dyes amounts to: i) 1% or less, preferably to 0.1% or less, of the peak emission intensity of the respective dye; ii) 30% or less of the peak emission intensity of the respective dye; iii) up to 100% of the peak emission intensity of the respective dye; or iv) in the range between 30%-100% of the peak emission intensity of the respective dye.
30. The system according to any one of preceding items, wherein the switching of the device into the first configuration (or state) is triggered by the provision of the light pulse/s such that the imaging device is switched into the first configuration (or state) simultaneously with or within 2 microseconds after the emission of any one of the first and second excitation light pulse/s.
31. The system according to any one of preceding items, further comprising one or more of the following: a trigger unit (e.g., an exemplary trigger unit as described herein), an excitation unit (e.g., an excitation unit as described herein), a transmission unit (e.g., an exemplary transmission unit as described herein), a detection unit (e.g., an exemplary detection unit as described herein) and safety enclosure (e.g., an exemplary safety enclosure as described herein).
32. The system according to any one of preceding items, wherein said system does not comprise a movable optical filter or a movable optical filters array.
33. The system according to any one of preceding items, wherein said system comprises only one optical filter.
34. The system according to any one of preceding items, wherein said system comprises a high-power excitation source in combination with InGaAs SWIR detectors and SWIR illuminated fluorophores (e.g., polymethine dyes, e.g., as described in examples section herein, e.g., ICG and/or Julo7 or elsewhere, e.g., in WO 2018/226720A1).
35. The system according to any one of preceding items, wherein said system is capable of High Dynamic Range (HDR) imaging.
36. The system according to any one of preceding items, wherein said system is capable of a real-time imaging.
37. Use of the system according to any one of preceding items in one or more of the following:
   i) an in vivo, ex vivo and/or in vitro method (e.g., a non-invasive method);
   ii) a diagnostic, therapeutic, surgical (e.g., intraoperative imaging, fluorescence guided surgery) and/or screening method (e.g., management and treatment of voice disorders);
   iii) a tissue engineering and/or transplantation method;
   iv) a three-dimensional (3D) bioprinting method;
   v) a real-time imaging method (e.g., real-time multiplexed imaging in non-transparent animals e.g., as described in the examples section herein);
   vi) a fluorescence imaging method;
   vii) a multicolor real-time image acquisition (e.g., in SWIR, e.g., as described in the examples section herein, e.g., Imaging of Awake State, Intestinal Mobility Tracking, Lymphatic Imaging);
   viii) a high-dynamic range image acquisition (e.g., in SWIR, e.g., as described in the examples section herein);
   ix) a dark-current noise-less imaging (e.g., in SWIR, e.g., as described in the examples section herein);
   x) a three-dimensional imaging (e.g., in SWIR, e.g., as described in the examples section herein);
   xi) a strobo-effected image acquisition (e.g., in SWIR, e.g., as described in the examples section herein);
   xii) an emission and excitation fingerprint (e.g., as described in the examples section herein)
   xiii) a method for reduction of melanin absorption in the SWIR;
   xiv) a method for a non-invasive imaging of tissues and/or organisms (e.g., with or without markers such as fluorescent dyes) in the presence of melanin;
38. A polymethine fluorophore compound (e.g., as described in Example 9 herein below, or elsewhere, e.g., in WO 2018/226720 A1), preferably said compound comprises the moiety having the following formula:

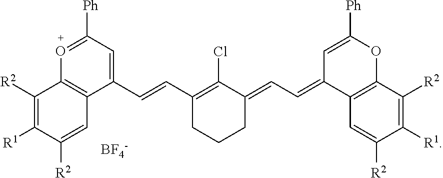

39. A composition comprising the polymethine fluorophore compound according to any one of preceding items.
40. The composition according to any one of preceding items, wherein said composition is a diagnostic composition.
41. The polymethine fluorophore compound according to any one of preceding items, for use in one or more of the method or system according to any one of preceding items.
42. Use of the polymethine fluorophore compound according to any one of preceding items in one or more of the following:
   i) an in vivo, ex vivo and/or in vitro method (e.g., a non-invasive method);
   ii) a diagnostic, therapeutic, surgical (e.g., intraoperative imaging) and/or screening method (e.g., management and treatment of voice disorders);
   iii) a tissue engineering and/or transplantation method;
   iv) a three-dimensional (3D) bioprinting method;
   v) a real-time imaging method (e.g., real-time multiplexed imaging in non-transparent animals e.g., as described in the examples section herein);
   vi) a fluorescence imaging method;
   vii) a multicolor real-time image acquisition (e.g., in SWIR, e.g., as described in the examples section herein, e.g., Imaging of Awake State, Intestinal Mobility Tracking, Lymphatic Imaging);
   viii) a high-dynamic range image acquisition (e.g., in SWIR, e.g., as described in the examples section herein);
   ix) a dark-current noise-less imaging (e.g., in SWIR, e.g., as described in the examples section herein);
   x) a three-dimensional imaging (e.g., in SWIR, e.g., as described in the examples section herein);
   xi) a strobo-effected image acquisition (e.g., in SWIR, e.g., as described in the examples section herein);
   xii) an emission and excitation fingerprint (e.g., as described in the examples section herein).

### EXAMPLES OF THE INVENTION

The imaging system was assembled according to FIG. 2, Table 1 (e.g., a component of the system of the present invention) and Table 2 and exemplary non-limiting specifications as described herein above.

### Example 1: High-Dynamic Range (HDR) Image Acquisition in SWIR

Due to reduced photon scattering in tissues and distinguished optical properties of biological-structures in SWIR, the florescence imaging in SWIR range enables observation of complex biological structures. The clarity and detail of the acquired image data are largely constrained by dynamic range limitations of digital imaging. In visible-range digital imaging, HDR imaging methods are employed to increase dynamic range of the acquired image data to improve image detail. Construction of HDR image is performed by combining multiple images obtained with varied exposure times and estimating relative illumination values for each pixel.

Technical Challenge

Applying HDR imaging methods in SWIR imaging is challenged by higher noise levels in SWIR detectors. The cumulative noise in SWIR detectors are combination of read noise, dark-current and random noise. The dark-current noise increases with the operating-temperature of detector. Varied exposure time settings in detector changes the detector operating temperature due to the Ohmic effects in its electronics. Hence, the cumulative noise floor in most commercial SWIR detectors is not identical with varied exposure settings. This varies the achievable dynamic range in each image acquired for HDR image construction. Therefore, mapping functions of conventional HDR image construction methods cannot be extended linearly, challenging the HDR imaging in SWIR range.

Solution Using the Developed Imaging System

Alternative, yet equivalent HDR image data can be generated by employing a controllable light source and constant detector exposure setting. The developed system (depicted in FIG. 2) can acquire HDR source images with constant detector exposure time setting and varying light emission durations of constant intensity. The acquired images with different light exposure duration are then combined to construct HDR images by adopting HDR image generation methods used in the visible-range digital photography. The SWIR illuminated HDR images can represent a greater range of brightness and contrast levels than that can be achieved with single image with constant exposures. This enables more detailed observation of target fluorophores and biological structures in SWIR spectrum.

Demonstration

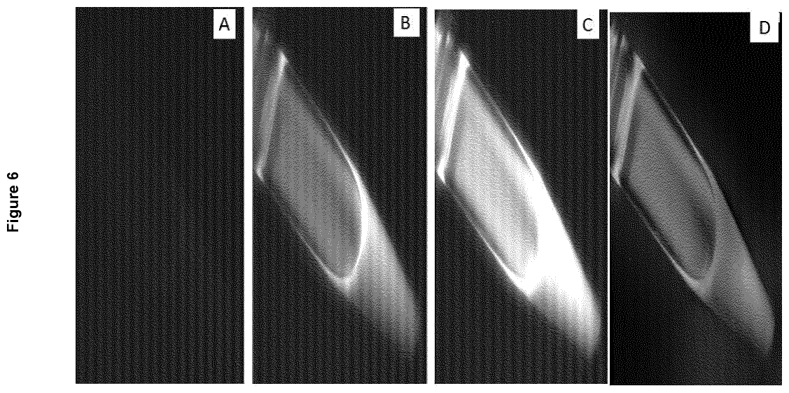

The FIGS. 6A, 6B and 6C show images of an Indocyanine green sample acquired with constant detector exposure setting of 200 ms excited by a 785 nm wavelength light source. With constant light intensity, they are acquired for 10 ms, 69 ms and 148 ms light pulse durations respectively. The FIG. 6D shows the processed SWIR HDR image.

Excitation-side Optics:

Light Source (785 nm laser)→Collimator→Mirror→1100 nm Short-pass Filter→Engineered Diffuser→Sample. The arrows represent the light path. Accordingly, the light path has been set up as follows: from Light Source (785 nm laser) to Collimator to Mirror to 1100 nm Short-pass Filter to Engineered Diffuser to Sample.

Emission-Side Optics:

Sample→3xf=500 mm C-Coated lenses→Silver Mirror→1000 nm Long-pass Filter→2xf=200 mm C-coated lenses→InGaAs Detector. The arrows represent the light path. Accordingly, the light path has been set up as follows: from Sample to 3xf=500 mm C-Coated lenses to Silver Mirror to 1000 nm Long-pass Filter to 2xf=200 mm C-coated lenses to InGaAs Detector.

Detector: Allied Vision Goldeye G032 GigE TEC2,

Trigger Controller: Version 1.5 (FIG. 4).

Sample: Indocyanine green dissolved in ethanol (1 mg/ml).

Conclusion: the construction of high dynamic range images (HDRIs) can be performed by combining multiple images obtained with different exposures and estimating the irradiance value for each pixel. This is a method for achieving HDRI acquisition with visible range detectors. By employing a controllable current source, the designed system can acquire images with constant detector exposures and varying light source emission duration with constant intensity. The acquired images with different light exposure durations, then combined to construct high dynamic range images. Such SWIR illuminated HDR images can represent a greater range of brightness and contrast levels than that can be achieved with single image with constant exposure enables more detailed observation of biological structures.

### Example 2: Multicolor Real-Time Image Acquisition in SWIR

Real-time acquisition of multicolor image data may open frontiers of biological investigation to study living organisms and develop medical diagnostics. Multicolor traces can be dynamically labelled to identify bio-structures and/or states of a biological sample. Combined with emerging technologies such as machine vision, learning and embedded robotics, the dynamic labels could enable deeper understanding of bio-chemical processes in living organisms and targeted and/or autonomous development of medical diagnosis. The developed system is capable of performing real-time, multicolor fluorescence image acquisitions in short-wave infrared. Some of the direct application of this methodology enabled by the developed system are as follows:

Imaging of Awake Mice: Ability to image an awake mouse in real-time multicolor enables to study the effects of anesthesia on the physiology of mice (cardiovascular function, respiratory function, thermoregulation, metabolism, central nervous system functions). And the ability to acquire such image data in SWIR range of electro-magnetic spectrum adds the advantages of reduced tissue scattering and increased image contrast.

Intestinal Mobility Tracking: Studying the intestinal mobility and its behavior allows monitoring of disease and the effect of pharmaceutic agents. The intestine motion could be affected by the irritable bowel syndrome, inflammatory bowel disease or chronic intestinal pseudo-obstruction. Furthermore, studying intestinal mobility in premature infants might/could allow diagnosing the condition necrotizing enterocolitis earlier and without use of ionizing radiation.

Lymphatic Imaging: Imaging the lymphatic system is useful for surgical imaging for dissection, diagnosis, studying and monitoring of lymphatic diseases such as lymphederna and to assess the tissue rejection in animal models.

Technical Challenge

Existing technologies to realize real-time, multicolor imaging either use multiple detector-light units or mechanically coupled rotating filter components. Use of multiple detector units significantly increases the system cost. And introducing rotating optical filter components impact or change the optical characteristics between the acquired channels.

Solution Using the Developed Imaging System

The developed system performs sequential triggering of the excitation sources and collects image data using a single detector unit. This provides the unique opportunity to image the physiology of awake mice with multiplexed detection in video rate (˜30 FPS) without any introduced optical artifacts in the acquired image data. The color channels can be configured by pre-determined combination of excitation sources and VIS/NIR/SWIR probes. Independent controlling of multiple light sources and detection unit eliminates the need for moving parts in the imaging system and increases the system life-time and reliability.

Demonstration I: Imaging of Awake Mouse

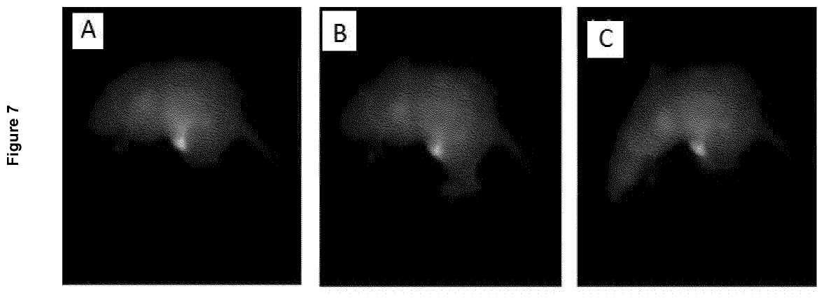

The FIGS. 7A, 7B and 7C show merged frames of the awake mouse in motion imaged in real-time with two color spectra of 6 ms detector exposure duration. In this configuration, a frame rate of 50 fps is achieved with the developed system.

Excitation-side Optics:

Light Sources (785 nm laser & 1064 nm laser sequentially triggered, Pulse Width=8 ms)→Collimator→Mirror→1100 nm Short-pass Filter→Engineered Diffuser→Sample. The arrows represent the light path. Accordingly, the light path has been set up as follows: from Light Sources (785 nm laser & 1064 nm laser sequentially triggered, Pulse Width=8 ms) to Collimator to Mirror to 1100 nm Short-pass Filter to Engineered Diffuser to Sample.

Emission-Side Optics:

Sample→1xf=750 mm C-Coated lenses→Silver Mirror→1100 nm Long-pass Filter→2xf=200 mm C-coated lenses→InGaAs Detector. The arrows represent the light path. Accordingly, the light path has been set up as follows: from Sample to 1xf=750 mm C-Coated lenses to Silver Mirror to 1100 nm Long-pass Filter to 2xf=200 mm C-coated lenses to InGaAs Detector.

Detector: Allied Vision Goldeye G032 GigE TEC2,

Trigger Controller: Version 1.5 (FIG. 4).

Sample: ICG (aqueous, 13 nmol intravenously) and Julo7 (micelles, 35 nmol intravenously).

Demonstration II: Intestinal Mobility Tracking

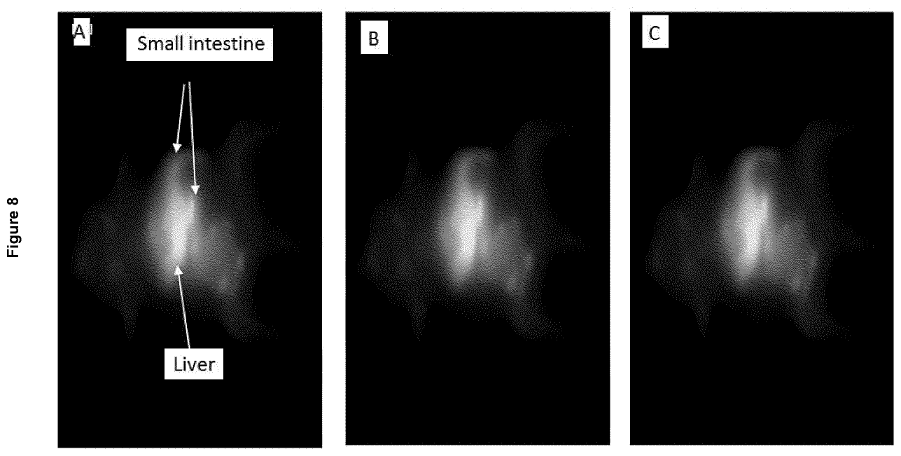

The FIGS. 8A, 8B and 8C show merged frames representing peristatic motions of a narcotized mouse in real-time two-color spectrum. With detector exposure time of 6 ms, a compound frame rate of 62 fps is achieved with the developed system. The ability to image with two colors removes the necessity to draw overlays of SWIR information on a visible or NIR range image.

Excitation-Side Optics:

Light Sources (785 nm laser & 1064 nm laser sequentially triggered, Pulse Width=8 ms)→Collimator→Mirror→1100 nm Short-pass Filter→Engineered Diffuser→Sample. The arrows represent the light path. Accordingly, the light path has been set up as follows: from Light Sources (785 nm laser & 1064 nm laser sequentially triggered, Pulse Width=8 ms) to Collimator to Mirror to 1100 nm Short-pass Filter to Engineered Diffuser to Sample.

Emission-Side Optics:

Sample→1xf=750 mm C-Coated lenses→Silver Mirror→1100 nm Long-pass Filter→2xf=200 mm C-coated lenses→InGaAs Detector. The arrows represent the light path. Accordingly, the light path has been set up as follows: from Sample to 1xf=750 mm C-Coated lenses to Silver Mirror to 1100 nm Long-pass Filter to 2xf=200 mm C-coated lenses to InGaAs Detector.

Detector: Allied Vision Goldeye G032 GigE TEC2,

Trigger Controller: Version 1.5 (FIG. 4).

Sample: ICG (aqueous, 13 nmol intravenously) and Julo7 (micelles, 35 nmol intravenously).

Demonstration III: Lymphatic Imaging

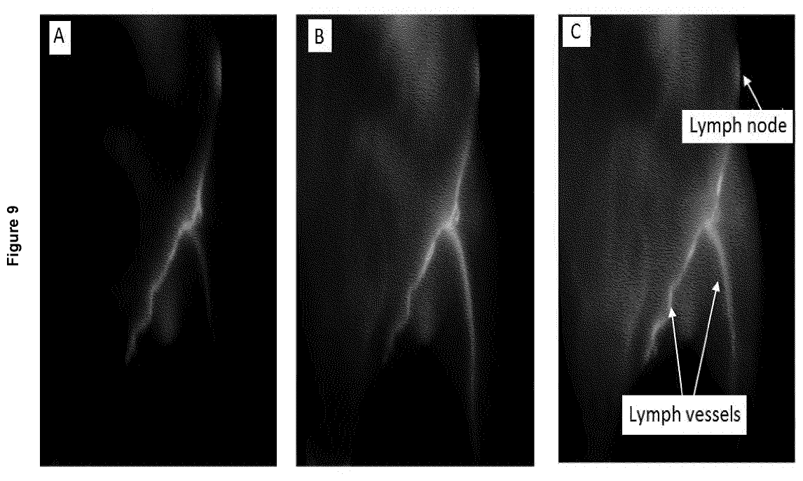

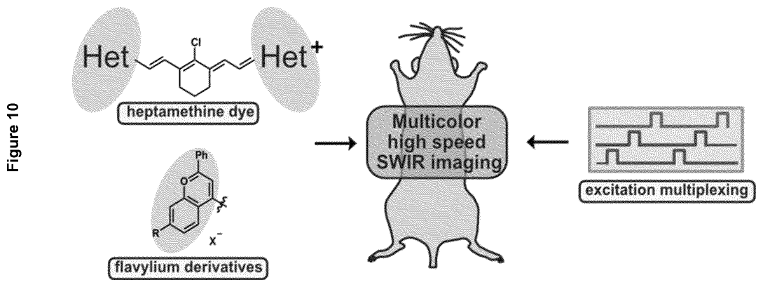

The FIGS. 9A, 9B and 9C show merged frames representing the lymphatic system of a narcotized mouse in two-color real-time acquisition. With detector exposure time of 20 ms, a frame rate of 21 fps is achieved with the developed system. For this demonstration, ICG has been injected intradermally into footpads and the base tail. After 30 min, ICG has been observed to be efficiently conducted through the lymphatic vessels. Then, Julo 7 micelles have been injected intravenously. The lymphatic functional imaging is later enhanced by the assignment of two distinct colors.

Excitation-Side Optics:

Light Source (785 nm laser & 1064 nm laser sequentially triggered, pulse length=21 ms)→Collimator→Mirror→1100 nm Short-pass Filter→Engineered Diffuser→Sample. The arrows represent the light path. Accordingly, the light path has been set up as follows: from Light Source (785 nm laser & 1064 nm laser sequentially triggered, pulse length=21 ms) to Collimator to Mirror to 1100 nm Short-pass Filter to Engineered Diffuser to Sample.

Emission-Side Optics:

Sample→3xf=500 mm C-Coated lenses→Silver Mirror→1000 nm Long-pass Filter→2xf=200 mm C-coated lenses→InGaAs Detector. The arrows represent the light path. Accordingly, the light path has been set up as follows: from Sample to 3xf=500 mm C-Coated lenses to Silver Mirror to 1000 nm Long-pass Filter to 2xf=200 mm C-coated lenses to InGaAs Detector.

Detector: Allied Vision Goldeye G032 GigE TEC2,

Trigger Controller: Version 1.5 (FIG. 4).

Sample: ICG (aqueous, 13 nmol intradermally [footpads and base of tail]) and Julo7 (micelles, 70 nmol intravenously).

Conclusion: by use of targeted SWIR fluorophores in different biological structures and/or states, the multicolor real-time image data acquisition can be achieved by the presented example (e.g., FIGS. 7, 8 and 9). The multi-spectral SWIR excitation sources can be switched sequentially and with clear temporal isolation to excite the targeted SWIR probes embedded in the biological sample. Each excitation would then correspond to SWIR emission stimulated by the fluorophores. This emission is then captured by the SWIR detector to form required image data. Using the sequential excitation information, acquired image data can be isolated and rendered in multicolor image information to produce real-time multicolor image data of the target biological subject.

### Example 3: Dark-Current Noise-Less SWIR Imaging

A general technical limitation of SWIR imaging is the detector introduced noise in the acquired image data. It greatly reduces the dynamic range of the detector in the long exposure durations due to increased dark-current. Though there exist solutions that can to some extent overcome these noise artifacts, such technologies often come at higher associated cost. A cost-effective solution is to acquire SWIR image in shorter exposure-times where the dark-current noises are significantly less than the read-noise of the detectors. This can be realized by the presented embodiment by producing high-intensity short-duration excitations by the controlled light sources. By keeping the average power within the safety limits, the biological structure can be imaged in short-exposure duration with high-sensitivity of optical signal.

### Example 4: Three-Dimensional Imaging in SWIR

By acquiring/illuminating from different angles one can create 3D real-time multicolor images. Which provides the opportunity to assess for example the behavior and physiology in awake and unrestrained animals without motion artefacts which are associated with longer exposure times.

### Example 5: Strobo-Effected Image Acquisition in SWIR and Stroboscopy Analysis in SWIR

Stroboscopic imaging of vocal fold vibratory function during phonation used to derive diagnostic, therapeutic, and surgical decisions during the management and treatment of voice disorders. While newer laryngeal imaging technologies such as high-speed video-endoscopy (HSV), magnetic resonance imaging, and optical coherence tomography continue to enhance the ability to better define and quantify complex phonatory mechanisms, the cost effectiveness, ease of use, and synchronized audio and visual feedback provided by video-stroboscopic assessment maintain its predominant clinical role in laryngeal imaging. The application of video stroboscopy can be performed in the SWIR spectrum with the developed system.

Technical Challenge

Limitations on sampling rate often prevent stroboscopic imaging from capturing cycle-to-cycle details of vocal fold vibratory characteristics. Therefore, achieving standard video frame rates in multiple spectrum is crucial to synthesize a SWIR stroboscopy. Due to the techno-economic constraints in the SWIR detector development, a video-rate multi-spectral SWIR imaging device is not available for commercial use preventing the extension of video-stroboscopic assessments in shortwave infrared.

Solution Using the Developed Imaging System

As explained in the application example 2 and application example 7, the developed system can perform sequential triggering of excitation sources and collect image data using a single detector unit. Hence the basis to acquire images of a same subject in several distinct SWIR spectra in video rate is achieved. By combining the acquired images of the same subject in distinct SWIR spectrum, multicolor movies and the video-stroboscopic assessment can be synthesized in the post processing.

Conclusion: the high-speed triggering and acquisition allows the device to act as a stroboscope, allowing to see continuous moving objects as stationary. Imaging in this way in the SWIR might allow differentiation of fluid filled pathological structures (e.g., abcesses) and non fluid filled structures (e.g., cysts).

### Example 6: Emission & Excitation Fingerprint

Acquiring images in different wavelength bands allows the creation of an image that provides a spectrum of the specimen at every pixel location throughout the lateral dimensions. Thus, the image stack can be considered as a collection of different wavelengths at each pixel location. Each fluorophore has a unique spectral signature or emission fingerprint that can be determined independently and used to assign the proper contribution from that probe to individual pixels. The linear unmixing is the generation of distinct emission fingerprints for each fluorophore used in the specimen (or excitation fingerprints if excitation rather than emission spectra were employed to generate the stacks (3)). This allows for separation of autofluorescence background and emission of a label of interest.

### Example 7: Real-Time Reflectance Imaging in Short-Wave Infrared

The varying SWIR reflectance and/or absorbance properties of physical matters can be explored using the developed system. Although certain organic and inorganic matters possess indistinguishable properties in the visible spectrum, reflective multicolor imaging in the SWIR spectrum can provide fine details of such matters due to the distinct properties of considered matters in this SWIR range. For example, water with protium hydrogen is an absorbent in certain SWIR range whereas the water with deuterium hydrogen is not. Such difference in the optical properties of different matters can be exploited to construct a multicolor SWIR imaging in real-time to study the motion state and/or structure of the physical samples.

Technical Challenge

Although there exist mature CMOS detectors for multi spectral visible range imaging applications, available SWIR detector technologies (such as InGaAs sensors, MCT sensors etc.) are not capable of performing a direct on-chip real-time multicolor image acquisition due to techno-economic constraints.

Solution Using the Developed Imaging System

As explained in the application example 2 above, the developed system can perform sequential triggering of the excitation sources and collect image data using a single SWIR reflection detector unit. This provides the basis to real-time acquire images of a same subject in several distinct SWIR spectra. Same as in example 2, the color channels can be configured by pre-determined combination of excitation sources. By combining the acquired images of the same subject in distinct SWIR spectrum, multicolor movies can be synthesized in the post processing. The developed system can reach a nominal frame rate of 100 fps shared by two-three color channels, enabling structural changes/motion detection in biological samples.

### Example 8: Cost-Effective SWIR Imaging Using Non-Scientific Cameras

Due to the low bandgap of InGaAs material, InGaAs FPA cameras have much higher dark current than Si-CCD cameras. Therefore, it is absolutely critical to minimize InGaAs FPA cameras' dark noise with embedded cooling systems. Scientific InGaAs FPA cameras often use thermoelectric cooling and vacuum technology to cool the camera sensors well below the ambient temperature to achieve the lowest possible dark noise. Use of such embedded cooling systems significantly increases the cost of the camera and its form factor.

Technical Challenge

InGaAs FPAs are dark-noise-limited devices. Deep cooling well below the ambient temperature is required to reduce dark charge and preserve the signal-to-noise ratios needed for scientific applications. However, cooling the sensor below the ambient temperature would precipitate the humid air on the sensor chip. This could lead to reduced camera performance and shorten its lifetime. Commercially available scientific grade InGaAs detector camera systems employ vacuum chamber and liquid nitrogen-based cooling systems to cool the camera sensors without in the absence of humid air. This leads to larger camera form-factor and higher system cost of the detector device.

Solution Using the Developed Imaging System

The need for vacuum based cooling systems in non-scientific InGaAs camera can be eliminated by preserving lower detector exposure time and relatively increasing the intensity of the electromagnetic excitation. The average flux intensity of NIR/SWIR spectrum can be controlled within the limits specified for non-destructive tissue imaging by the SWIR developed imaging system. Here, the synchronized excitation sources provide enough flux intensity to acquire a SWIR image with short-pulsed excitations. By appropriately configuring the time resolution of the system, the average flux density can be maintained within the approved levels. Therefore, effects of dark current can be avoided and small form-factor lower-cost non-scientific cameras can be used for SWIR image acquisitions. This would vastly simplify the design of medical diagnostic instruments and reduce their production costs.

### Example 9: Real-Time Multiplexed Imaging in Non-Transparent Animals

The following approach has been employed to achieve multicolor whole animal imaging in high spatial and temporal resolution by parallel advances in polymethine fluorophore derivatives and whole animal excitation-multiplexing technologies (FIG. 10).

Thus far, non-invasive multiplexed experiments in animals have been limited to excitation of multiple probes with common wavelengths. Differentiation between contrast agents is achieved by either emission filter combinations to section spectral regions of detection, or by spectral unmixing. Approaches using multichannel single-detector imaging have prevented multiplexed fast acquisition to date as the filters employed must be changed for each channel. Additionally, signal is often limited in these methods by suboptimal excitation of multiple probes with a single wave-length, and by collection in narrow windows of the electromagnetic spectrum. Efficient excitation and economic photon detection are especially critical for the SWIR region where quantum yields are often below 1%. Finally, as the contrast and resolution one can obtain varies throughout the NIR and SWIR, this approach results in different resolutions for each channel.

An alternate method relies on differences in fluorophore excitation intensities instead of emission properties. Excitation-multiplexing enables a single “color-blind” detection source to be used, while excitation sources are modulated. Initially deemed pulsed multiline excitation in the development of low concentration DNA sequencing, high signal is favored by tuning excitation to the absorption maxima of each fluorophore and collecting over a larger emission regime. Temporal separation negates the need for spectral unmixing to determine dye identities. Variations on excitation-multiplexed methods including frequency-, as opposed to time-separated methods have been developed for fluorescence lifetime microscopy (FLIM), and super-resolution methods.

To accomplish real-time multiplexed imaging in non-transparent animals, a method is needed in which 1) SWIR detection is employed for high contrast, resolution, and penetration depth; 2) fluorophores are excited at their absorbance maximum and all SWIR photons are collected to achieve ample signal and; 3) detection of each channel can occur in tandem on the millisecond time scale. These requirements could, for example, be met by excitation-multiplexing and “color-blind” detection of custom, bright polymethine fluorophores.

Polymethine dyes, characterized by their narrow absorption and emission bands and high absorption coefficients, are a prime scaffold for excitation multiplexing. The ability to tune wavelengths of excitation and emission relies on structural changes to both the heterocycle and polymethine chain. A marque member of the polymethine dye family is indocyanine green (ICG), an FDA approved contrast agent used on-label for measuring cardiac and hepatic function and observing retinal angiography. Expanded clinical uses, including fluorescence guided surgery, are impending, and responsive probes based on the scaffold are in development. While ICG has been extensively used in NIR optical imaging, it was recently characterized to have a bright SWIR tail which can be imaged with InGaAs detection upon 785 nm excitation to obtain ˜2× higher resolution images than can be obtained with NIR detection on a CCD camera.

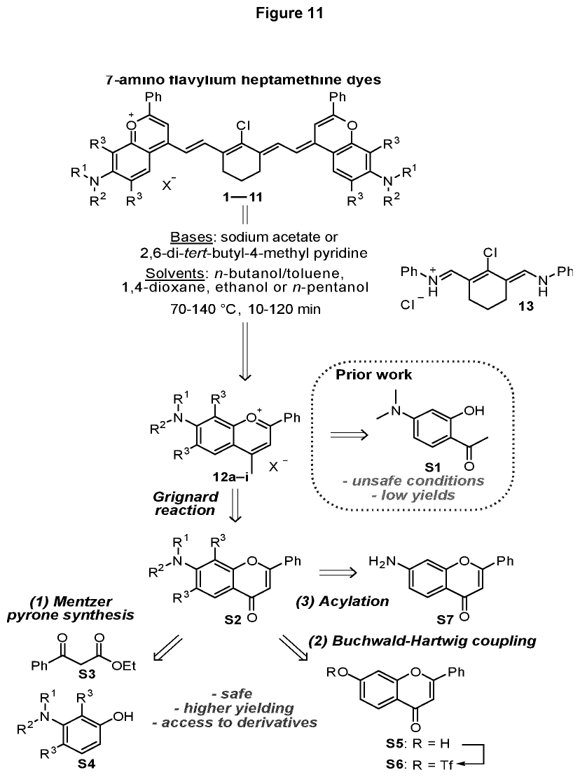

Capitalizing on the design of the existing fluorophore Flav7 (Cosco et al., 2017), it was hypothesized that functional group changes at the 7-position on flavylium (FIG. 11) could tune the absorption and emission profiles of the resulting fluorophore and allow access to a set of dyes which were optimal for real-time imaging via excitation multiplexing.

Symmetric polymethine dyes are obtained through a condensation reaction with two equivalents of an activated heterocycle and a bis-aldehyde or bis-imine vinylene chain. The preparation of the 7-N,N-dimethylamino-4-methyl-flavylium heterocycle 2 employed in Flav7 synthesis, was originally reported by Yang and coworkers (FIG. 11A) (Chen et al., 2008). The route involves a low yielding Fries-rearrangement to obtain 1, followed by an unreliable and unsafe condensation reaction. Furthermore, the success of these reactions is highly dependent on the steric and electronic properties of the heterocycle, limiting derivatization of the scaffold. Thus, to obtain flavylium-based polymethine dyes with diverse functionality on the heterocycle, it was imperative to develop a more versatile synthetic route to 7-amino substituted 4-methyl flavylium derivatives.

We envisioned that that diverse 4-methyl flavylium derivatives could be obtained from the requisite 7-substituted flavone by treatment with a methyl nucleophile and dehydration. Flavones have been common synthetic targets due to their pharmacological activity. Using three general routes to flavones: 1) Mentzer pyrone synthesis, a thermally induced condensation between a beta-keto-ester and a phenol; 2) functionalization of a commercial 7-hydroxy flavone by Buchwald-Hartwig coupling of the corresponding triflate; 3) acylation of the commercial 7-amino flavone, we were able to access a diverse set of 7-amino flavylium heterocycles (FIG. 11).

Specifically, by route 1), the alkylated amino flavones S2a-c were obtained in moderate yields, 51-55%, by subjecting a substituted 3-aminophenol (S4a-c) to ethylben-zoylacetate (S3) and heating neat for 20-48 h. In route 2) aliphatic and aromatic aminoflavones S2d-h were acquired by palladium catalyzed C—N coupling reactions of triflate S6 with a variety of secondary amines in 63-83% yield. Finally, by route 3), a BOC substituted 7-aminoflavone was synthesized by treatment of 7-aminoflavone S7 with BOC-anhydride in base with catalytic dimethylaminopyridine to obtain the doubly BOC protected product S2i in 75% yield. Each flavone was subsequently converted to the corresponding 4-methyl flavylium 12a-i in moderate to good yields (39-86%) by treatment with methyl Grignard and quenching with fluoroboric acid. The fluoroboric acid gives rise to a tetrafluoroborate counterion that is retained in the final dye species, as confirmed by 19F NMR. The 7-methoxy substituted 4-methyl flavylium 12j was synthesized according to a known route.

The heptamethine dyes were synthesized by the base-promoted reaction of 4-methyl flavylium heterocycles with bis(phenylimine) 13. The conditions required for successful dye formation proved to be dependent on the heterocycle used. Thus, the solvent and base used were tailored to each heterocycle and are summarized in Table 3.

Notably, the non-nucleophilic base 2,6-di-tert-butyl-4-methylpyridine facilitated efficient polymethine formation with few signs of degradation of the dye, as monitored by UV-Vis-NIR spectrophotometry. For most heterocycles (12a-d; 12g-j), 90-100° C. was sufficient to achieve fast (10-15 min) conversion to the heptamethine. The cyclic alkyl amine heterocycles 12e and 12f required either extended time (up to 120 min), or higher temperatures (up to 140° C.) for efficient reaction conversion.

TABLE 3
Parameters of flavylium heptamethine fluorophore synthesis.

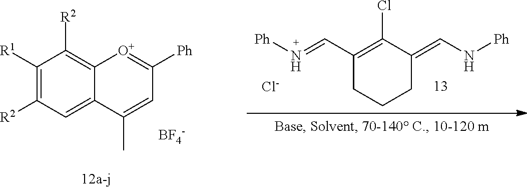

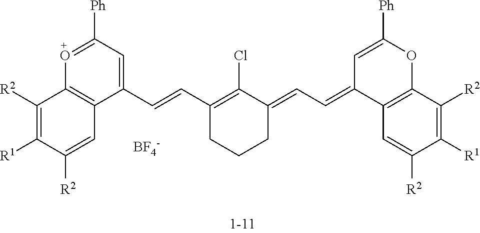

| Flavylium 8 | R¹ | R² | base^{a} | solvent | temp (° C.) | time (m) | yield # (%) | dye |
|---|---|---|---|---|---|---|---|---|
| 12a | 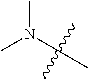 [SMILES: *N(C)C] | H | A | n-butanol/toluene | 100 | 15 | 51 | 1 |
| 12b | 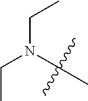 [SMILES: *N(CC)CC] | H | A | n-butanol/toluene | 100 | 10 | 40 | 2 |
| 12c | 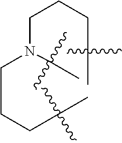 [SMILES: *CCCN(*)CCC*] | | A | ethanol | 70 | 120 | 37 | 3 |
| 12d | 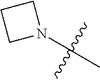 [SMILES: *N1CCC1] | H | A | n-butanol/toluene | 100 | 10 | 37 | 4 |
| 12e | 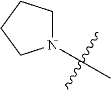 [SMILES: *N1CCCC1] | H | B | n-pentanol | 140 | 50 | 8 | 5 |
| 12f | 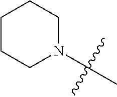 [SMILES: *N1CCCCC1] | H | B | n-butanol/toluene | 100 | 120 | 26 | 6 |
| 12g | 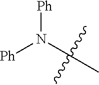 [SMILES: *N(c1ccccc1)c1ccccc1] | H | B | 1,4-dioxane | 100 | 15 | 11 | 7 |
| 12h | 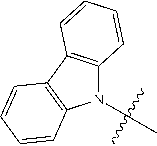 [SMILES: *n1c2ccccc2c2ccccc21] | H | B | 1,4-dioxane | 90 | 15 | 13 | 8 |
| 12i | 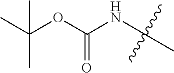 [SMILES: *NC(=O)OC(C)(C)C] | H | B | 1,4-dioxane | 95 | 15 | 33^{b} | 9 |
| 12j^{c} | 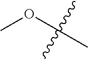 [SMILES: *OC] | H | B | n-butanol/toluene | 100 | 15 | 33 | 10 |
| — | 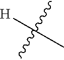 [SMILES: *[H]] | H | B | n-butanol/toluene | 90 | 45 | 5 | 11 |

^{a}base: A = sodium acetate; B = 2,6-di-tert-butyl-4-methyl pyridine
^{b}yield over two steps, flavylum #i not isolated in dye synthesis
^{c}counterion is Cl^{—}

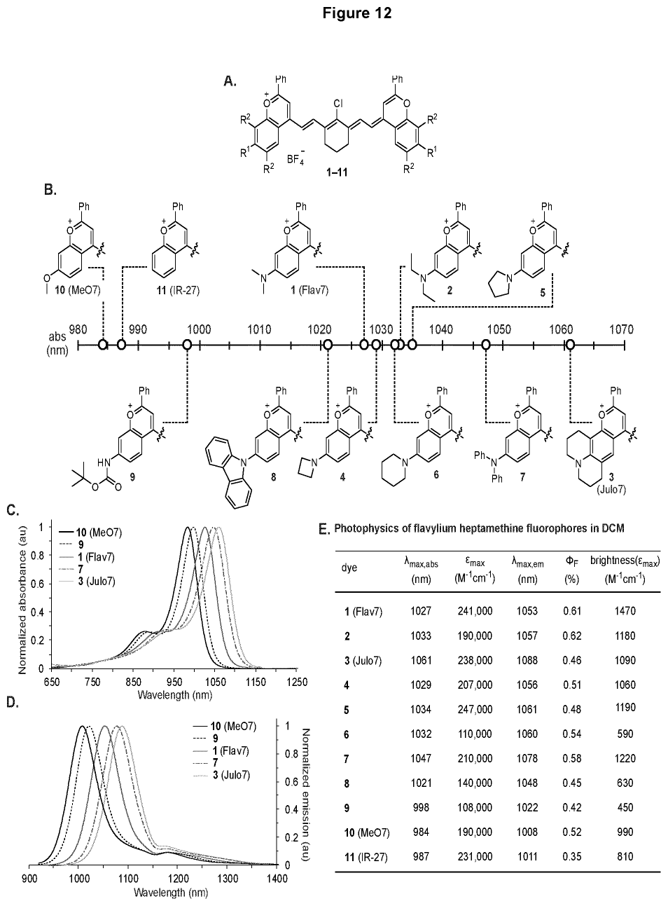

We characterized the absorptive and emissive properties of 1-11 in dichloromethane and found that the flavylium heptamethine dyes accessed have absorption and emission spanning the far-NIR to SWIR regions of the electromagnetic spectrum (FIG. 12). Compared to Flav7 1, with λmax,abs=1027 nm and λmax,em=1053 nm, 9 and 10 achieved significant hypsochromic shifts. As the highest energy absorber of the series, the 7-methoxy substituted dye 10 is ˜44 nm blue shifted from Flav7, with absorption at 984 nm, close to the 980 nm laser line, and emission at 1008 nm. Notably, the un-substituted flavylium dye 11, which was previously reported by Drexhage as IR-27, is ˜41 nm blue shifted from Flav7 and has a lower brightness (εmax). A carbazole derivative 8, has slightly blue shifted properties. Linear and cyclic aliphatic amine substituents resulted in dyes 2, 4-6, which exhibit minor red-shifts compared to Flav7. Conversely, dyes 3 and 7 underwent substantial batho-chromic shifts compared to Flav7. The diphenylamino substituted 7 is ˜23 nm red-shifted compared to Flav7, while julolidine derivative 3 is red-shifted by ˜35 nm with absorption at 1061 nm and emission at 1088 nm. Due to its absorption maximum and high brightness (εmax), 3 was a promising candidate for SWIR imaging with 1064 nm excitation and was named Julo7. Plotting absorption and emission wavelengths of nine dyes in the series (omitting the aromatic derivatives 7 and 8) against the Hammett om values, resulted in a linear correlation (R²=0.96). The empirical relationship of negative om values to longer absorption wavelengths indicates that the electronic donating ability of the substituent is indeed responsible for the red-shifted photophysical behavior. This increased understanding of the relationship between structural and absorption/emission wavelengths sets-up opportunities for predicting photophysical properties of the scaffold.

The absorption coefficients (E) of the series vary from ˜110,000 to ˜240,000 M⁻¹cm⁻¹. High absorption cross sections are characteristic for many polymethine fluorophores and are essential for obtaining high-quality video-rate images in the SWIR. The fluorescence quantum yields (Φ_{F}) (relative measurements to IR-26=0.05%) remain rather constant, in the 0.4 to 0.6% range, despite red- or blue-shifted behavior, providing a platform for intensity-matched probes. Combined, high ε and Φ_{F} values for the SWIR result in a bright dye series: six dyes (1-5, 7, and 10) have a brightness (εₘₐₓ) 1000 M⁻¹cm⁻¹. High brightness, combined with varied absorption and emission wavelengths, poise the series for real-time, excitation multiplexing in the SWIR.

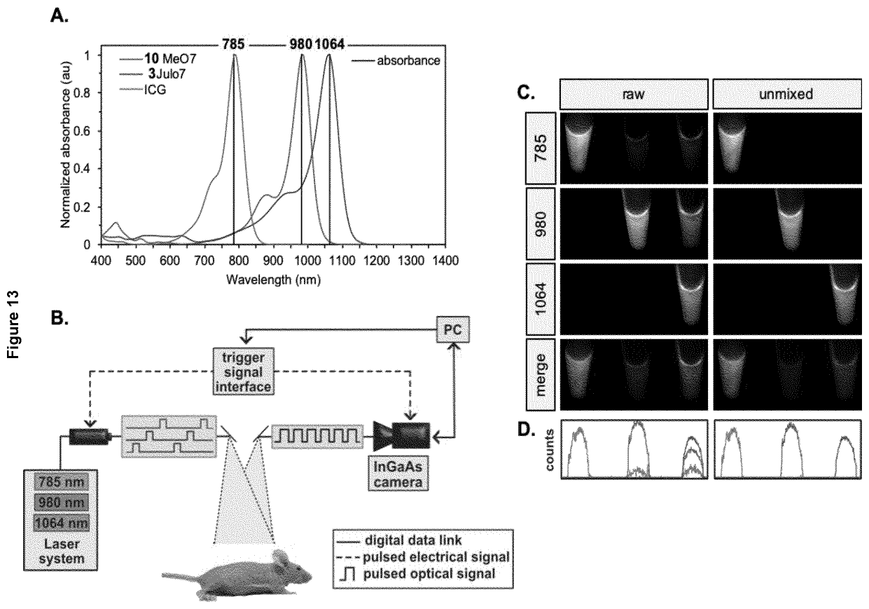

For excitation multiplexing, we are most interested in properties of the series of polymethine fluorophores when exited at 980 and 1064 nm. Thus, we calculated brightness (ε_{λ}) values for each dye using the absorbance coefficient at the respective wavelengths. It is clear that the original fluorophore Flav7 is not suited for excitation multiplexing as it has similar brightness (ε_{λ}) values at λ=980 and λ=1064 nm. Gratifyingly, clear candidates emerge for imaging at these common wavelengths, with 3 (Julo7) being superior for imaging at 1064 nm (brightness (ε₁₀₆₄)=1090±40 M⁻¹cm⁻¹) and 10 (MeO7) having the advantage at 980 nm (brightness (ε₉₈₀)=980±20 M⁻¹cm⁻¹). The parings can be further visualized by observing the absorption profiles and excitation wavelengths on the same plot (FIG. 13A). A third color can be achieved with the heptamethine ICG, which is well-matched to 785 nm excitation.

To perform excitation multiplexing in the SWIR, a custom SWIR imaging configuration with three lasers and an InGaAs detector was built (FIG. 13B). With laser lines at 785 nm, 980 nm, and 1064 nm, tailored excitation could uniquely excite three fluorophores. Emission is detected in a color-blind fashion using identical filters and settings in the SWIR, providing high-resolution images. To enable this process to occur in real-time, we constructed an electronic triggering system which is coupled to both the camera and laser excitation sources. Triggers on the millisecond time scale are sent independently to each CW laser and the detector and programmed to collect a single frame for each sequential excitation pulse. The detection unit and triggering unit were integrated with MATLAB into a control unit (PC) which collects, stores and displays the collected data in real-time. In effect, a modular system resulted, in which wavelengths used and exposure time could be tuned to the experimental conditions. While the effective frame rate of collection was slowed by a factor equal to the number of channels, video-rate acquisition was still achievable in this method due to the low exposure times needed.

To test the performance in vitro, vials containing solu-ions of ICG (left), and flavylium dyes 10 (center) and 3 (right) were imaged with the custom configuration (FIG. 13B). Three successive frames show high intensities at the left (frame 1), center (frame 2) and right (frame 3), matching the locations of each vial (FIG. 13C-D). Merging the 3 frames together yields a three colored image representing one effective multiplexed frame (FIG. 13C-D). Because molecules cannot absorb light at energies lower than their S0 to S1 transition, cross-talk occurs only in one direction, is minimal, and can be unmixed by image processing.

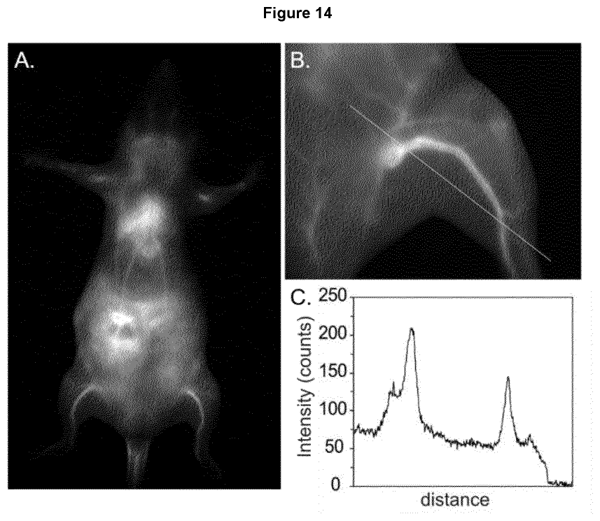

Before performing multiplexed experiments in vivo, imaging with 1064 nm excitation using 3 (Julo7) as a contrast agent was optimized. To facilitate its dispersion in water, 3 was encapsulated in PEG-phosopholipid micelles. The resulting micelles remained stable for at least one week and retained absorptive and emissive properties of the dye in organic solvent. Micelles were introduced by tail vein injection into anesthetized mice and immediately imaged with ex. 1064 nm (FIG. 14A). Due to the large amount of signal achieved, we were able to obtain images at 100 fps, with an 8 ms exposure time, collecting from 1100-1700 nm. These fast speeds suggested that high-quality images could still be obtained upon multiplexing. Moving to detection with 1200 nm LP allowed for more enhanced contrast and spatial resolution FIG. 14B-C).

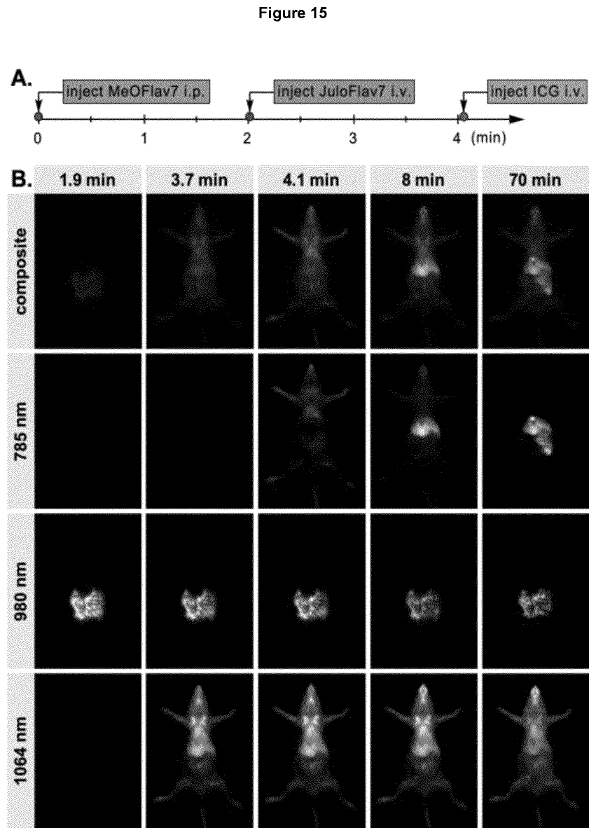

To obtain real-time images in three colors, heptamethine 10 was encapsulated in PEG-coated micelles to impart water solubility. In vivo, we introduced 10 micelles by intraperitoneal injection, and 3 micelles followed by ICG by intravenous injection. Representative time points of the three-color video are displayed in FIG. 15. After establishing both the technology and the molecular tools for multiplexed real-time observation of function in mice, the next goal was to enhance existing SWIR imaging applications.

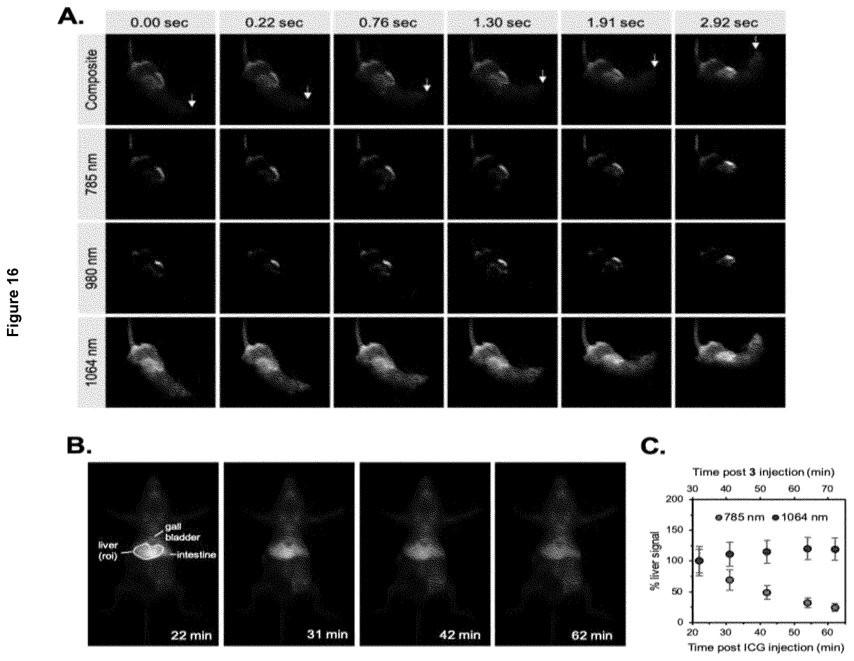

Physiological properties such as heart-rate, respiratory rate, thermoregulation, metabolism, and the function of the central nervous system, are highly impacted by anesthesia. Methods to observe animals in their natural state are necessary to study physiology, but are currently limited to telemetric sensors and electrocardiography, which involve surgical implantation or external contact, respectively. Recently, high-speed SWIR imaging has enabled contact-free monitoring of physiology in awake mice. Due to frame rates which are faster than macroscopic movements in animals, the heart rate and respiratory rate in awake animals can be quantified. In this study, we expanded this technique by observing awake mice in three colors. The method allows physiology to be monitored with minimal perturbation of the animal's usual environment. In FIG. 16A, awake mouse imaging was performed 80 minutes after i.p. administration of 10 micelles and consecutive i.v. administration of 3 micelles and ICG. From the top-view of the mouse, ICG could be visualized exclusively in the liver, 10 micelles in the abdomen, while 3 micelles remained systemically distributed throughout the mouse. The real-time collection can be visualized by observing close time-points in which a continuous movement is monitored without visual aberrations (FIG. 16A). In addition to assessing natural physiology, these tools foreshadow more complex experiments in which the location of multiple probes could be monitored over long periods of time, non-invasively and without the need for anesthesia.

Secondly, biological reference can be added to existing experiments which visualize a single organ or organ system. Beyond its approved clinical practices, many off-label uses of ICG have been established. ICG clears efficiently and exclusively from the liver. Relying on this property, methods to study intestinal mobility in the presence of disease or pharmacological agents have been developed. By adding a second channel in these experiments, we anticipated that the liver and intestines could be visualized within the context of the adjacent structures. To demonstrate this application, we injected 3 micelles and ICG consecutively through the tail vein and imaged the whole mouse at several time points over a one-hour period. In the duration of the experiment, the signal from the 1064 nm channel remained constant, serving as a stationary reference for changes in the 785 nm channel in the intestine (FIG. 16B-16C).

Conclusion: enabled by a set of flavylium heptamethine dyes with diverse wavelength excitation and by a triggered multi-excitation SWIR optical configuration, multiplexed whole animal imaging with high spaciotemporal resolution was demonstrated. The technologies developed in the course of this invention advance the ability to monitor orthogonal function in animals, a major advance in imaging methods.

Selected Advantageous Features of the System of the Present Invention:

Full control over excitation and detection enabling multiple applications. Imaging in the SWIR region benefiting from less scattering, autofluorescence, etc. Possibility to image off-peak, emission signal of fluorophores sufficient off-peak. Multi-Color real-time imaging in the SWIR. Compatible with Matlab and Simulink programming environments. 16 MHz 32 bit AVR Microcontroller based trigger unit. Flexible and reconfigurable optical system.

### Example 10: Bright Polymethine Emitters for Multiplexed Shortwave Infrared In Vivo Imaging

Introduction

Optical detection in the shortwave infrared (SWIR, 1000-2000 nm) region of the electromagnetic spectrum furnishes high sensitivity and high-resolution imaging in mammals. The enhanced performance arises from lower scattering coefficients and reduced tissue autofluorescence in the SWIR compared with the near-infrared (NIR, 700-1000 nm) and visible (VIS, 350-700 nm) regions. Since the initial report of SWIR detection for deep-tissue optical imaging in 2009, diverse emitters for this region, including carbon nanotubes, quantum dots, rare-earth containing nanoparticles, and small molecules, have been optimized. These efforts have enabled improvements in imaging speed, up to ˜100 fps, and the translation of advanced imaging techniques, such as multicolor imaging, confocal microscopy, and light-sheet microscopy techniques, to this long wavelength region.

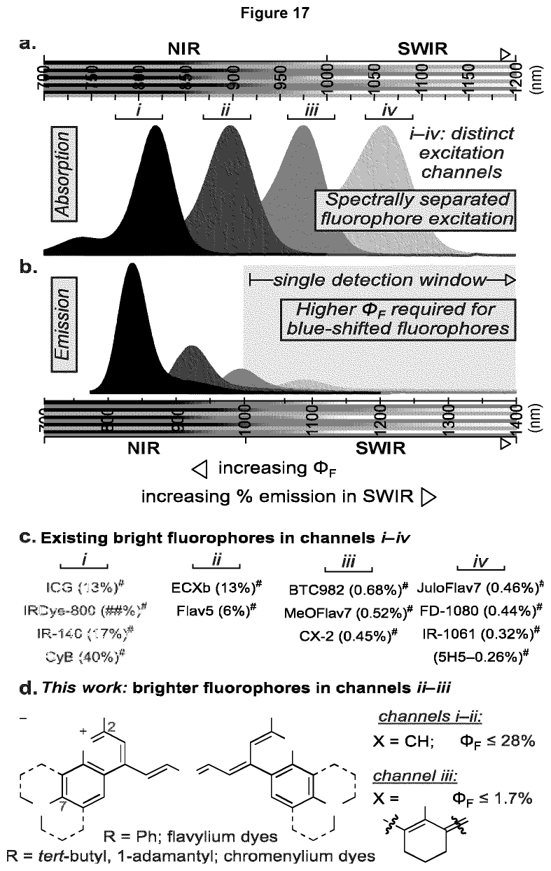

A new strategy for multiplexed non-invasive imaging in mammals is excitation-multiplexing with single-channel SWIR detection. This approach hinges on SWIR-emissive fluorescent probes with well-spaced absorption spectra that can be preferentially excited with orthogonal wavelengths of light (e.g., FIG. 17a) and detected in the SWIR (e.g., FIG. 17b) in tandem on the millisecond time scale. The approach benefits from similar contrast and resolution in all channels by maintaining the same detection window within the SWIR and allows fast switching between channels. The method enabled non-invasive, real-time, multi-channel imaging in living mice at video rate (27 frames per second, fps). Nonetheless, it was limited to three colors and produced some challenges in motion artifacts due to the ˜10 ms separation between channels. Faster acquisition speeds would minimize these limitations, allowing for enhanced temporal resolution in three-color imaging, and/or increasing the number of orthogonal excitation channels (and thus biological parameters) that can be acquired while maintaining video-rate acquisition.

To produce orthogonal signals from differing, well-separated (˜80 nm) excitation wavelengths across the NIR and SWIR, two classifications of emitters can be used: 1) fluorophores with SWIR absorption and emission, and 2) NIR-absorbing dyes which exhibit long wavelength emission tails extending into the SWIR region (e.g., FIG. 17). Imaging NIR dyes in the SWIR requires a higher overall brightness to compensate for the small fraction of the emission signal that is collected (e.g., FIG. 17b). Fortuitously, this concept aligns well with the energy gap law, allowing drastically higher fluorescence quantum yields (CDF) to be obtained with more blue-shifted dyes. However, apart from the FDA-approved indocyanine green (ICG, e.g., FIG. 17b), and analogues which are commonly excited between 785-808 nm, currently, there are few bright probes with NIR absorption greater than 800 nm (e.g., FIG. 17c, ii-iii). To improve both the speed and degree of multiplexing for non-invasive imaging in mammals, brighter dyes with narrow excitation spectra at wavelengths between 800-1000 nm can be used.

Small molecules are desirable contrast agents due to their small size, biocompatibility, and simple bioconjugation approaches. Polymethine dyes, fluorophores composed of two heterocyclic terminal groups connected by a vinylene chain, are ideal candidates for excitation multiplexing, as they have high absorption coefficients (E), often above ˜10⁵ M⁻¹cm⁻¹, and narrow absorption profiles which can be fine-tuned to match excitation channels. While red-shifted polymethine dyes often retain favorable absorptive properties, Φ_{F} values drop drastically in the far-NIR to SWIR regions. As brightness is reliant on both absorptive and emissive properties (brightness=εₘₐₓ·Φ_{F}; εₘₐₓ=absorbance coefficient at λ_{max,abs}), an ideal fluorophore will undergo both excitation and emission efficiently. Efforts to increase the quantum yield of polymethine dyes have included reducing non-radiative processes by interactions with biomolecules, introducing conformational restraint on the polymethine chain or by decreasing intersystem crossing by replacing heavy atoms. Further efforts to increase brightness in polymethines include reducing aggregation effects in biology to increase the amount of actively absorbing and emitting species that can be detected.

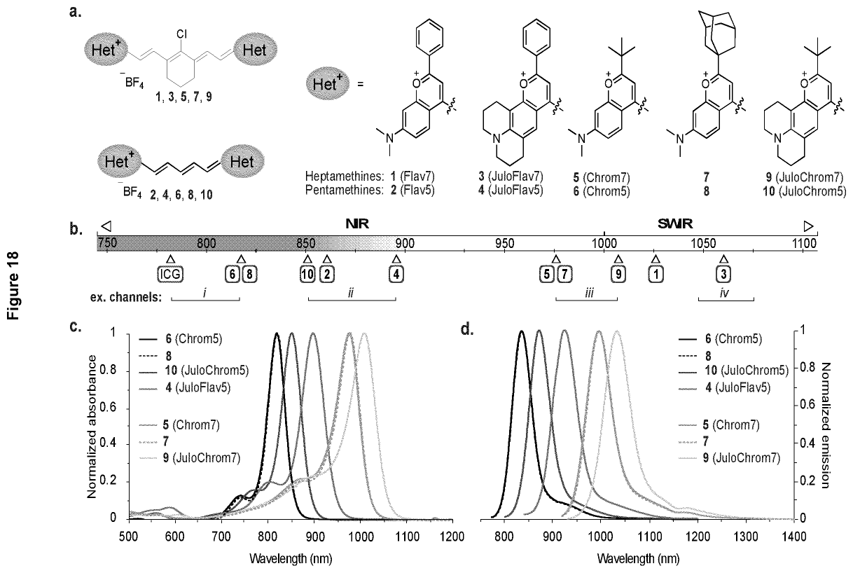

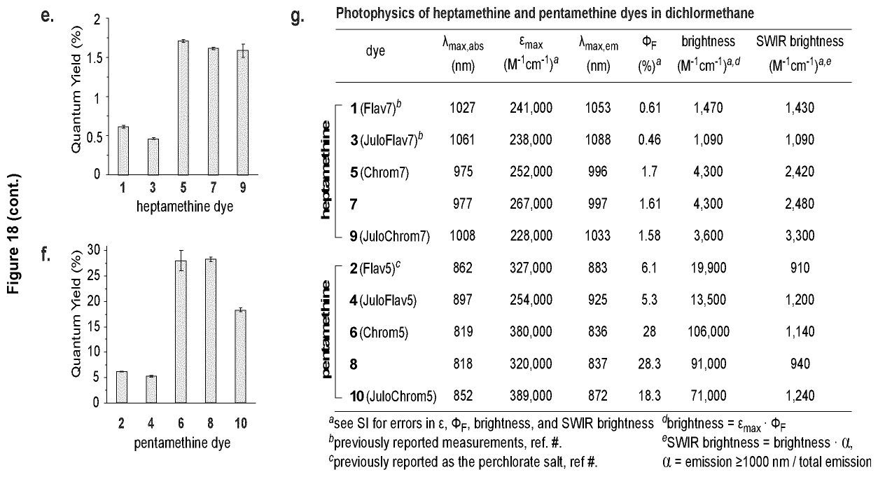

As a starting point to obtain far-NIR polymethine dyes with high brightness, oxygen-containing flavylium dyes, which have previously furnished bright SWIR-light absorbing molecules, were looked at. Fluorophores constructed from a 4-methyl-7-dimethylamino flavylium heterocycle include heptamethine dye 1 (Flav7, λ_{max,abs}=1027 nm, Φ_{F}˜0.5%) and pentamethine dye 2 (Flav5, λ_{max,abs}=862 nm, Φ_{F}˜5%), (e.g., FIG. 18a) which are 10-fold more emissive than the thiaflavylium counterparts, likely due to reduction in intersystem crossing. Investigation of structure-property relationships by systematic substitution of the flavylium heterocycle produced trends which could reliably red- or blue-shift excitation wavelengths but did not produce significant enhancements in the emissive properties, offering little insight into further increasing the brightness of the scaffold. In this example structural features on the heterocycle that increase the emissive behavior in long wavelength polymethine dyes were explored. The resulting dyes are applied to fast and multiplexed SWIR imaging in mice.

Results and Discussion:

Synthesis and Photophysical Characterization of SWIR-Emitting Polymethine Dyes:

It was hypothesized that rotational and vibrational modes within the phenyl group at the 2-position on flavylium (e.g., FIG. 17d) could be contributing to substantial internal conversion. To investigate this question, 4-methyl chromenylium heterocycles containing either a tert-butyl or a 1-adamanyl group at their 2-positions was targeted and applied to synthesize pentamethine and heptamethine dyes with absorption between 800-1000 nm (e.g., FIG. 18a-b).

It was found that the chromenylium heterocycles could be synthesized by an analogous route to the prior flavylium variants. From these heterocycles, the penta- and heptamethine chromenylium dyes 5-10 (e.g., FIG. 18a) were synthesized through the classic polymethine condensation reaction with the corresponding conjugated bis(phenylimine). Additionally, due to the ˜35 nm red shifted behavior that the introduction of a julolidine-containing flavylium heterocycle provided in the heptamethine dye 3 (JuloFlav7, λ_{max,abs=}1061 nm, Φ_{F}˜0.46%) compared to Flav7 (1), the pentamethine flavylium dye that would result from this same julolidine-containing heterocycle (4) was also investigated.

After preparation of the chromenylium dyes 5-10 as well as the previously reported flavylium dyes 1-3 and the new flavylium dye 4, a thorough comparative investigation of their photophysical properties was performed. The photophysical properties in dichloromethane reveal that the absorption and emission of the chromenylium heptamethine derivatives are blue shifted by λ˜52 nm (v˜500 cm⁻¹), and the chromenylium pentamethine dyes by λ˜44 nm (v˜600 cm⁻¹), from their flavylium counterparts (e.g., FIG. 18 b-c, 18g). The absorption coefficients remain characteristically high, with the pentamethines having, on average higher values than the heptamethines, at ˜360,000 M⁻¹cm⁻¹ and ˜250,000 M⁻¹cm⁻¹, respectively (e.g., FIG. 18g). Remarkably, the emissive properties were increased substantially, with heptamethine chromenylium dyes Φ_{F}=1.6-1.7% (relative measurements to IR-26=0.05%) and pentamethine chromenylium dyes Φ_{F}=18-28% (absolute quantum yield measurements) (e.g., FIG. 18e-g). Combining the absorptive and emissive properties, 5 and 7 have the highest brightness of the heptamethines at 4,300 M⁻² cm⁻¹, while 6 is the brightest pentamethine (106,000 M⁻¹cm⁻¹).

Comparing the brightness in organic solvent of the chromenylium dyes to reported values for current state-of-the-art organic fluorophores with similar absorption wavelengths in each excitation channel (dyes outlined in e.g., FIG. 17c), they fare quite well. For example, in region (i), Chrom5 (6) is brighter than ICG, IRDye-800, and IR-140 and displays similar similar brightness to the conformationally restricted Cy7 (notated here as Cy7B). JuloChrom5 (10) (in region ii) is ˜3.5-fold and ˜4 fold brighter than Flav5^{Fehler! Textmarke nicht definiert}. and ECXb^{Fehler! Textmarke nicht definiert}. respectively, while Chrom7 (5) (in region iii) is between ˜2.5-5-fold brighter than current standards BCT982, MeOFlav7, and CX-2. Thus, the series of chromenylium dyes provide bright organic chromophores with NIR-absorption.

When evaluating dyes for SWIR imaging, the more relevant brightness metric considers the percent of emission that is within the SWIR region. We accounted for this parameter by defining SWIR brightness=εₘₐₓ·Φ_{F}·α, where α=emission≥1000 nm/total emission, calculated from the emission spectra. All of the chromenylium heptamethine dyes have a higher SWIR brightness than the flavylium derivatives, despite their more blue-shifted photophysics (e.g., FIG. 18g). For the pentamethines, flavylium dye 4 and chromenylium dyes 6 and 10 are the brightest SWIR emitters of the series. Improved Φ_{F} values are due to reduced non-radiative rates:

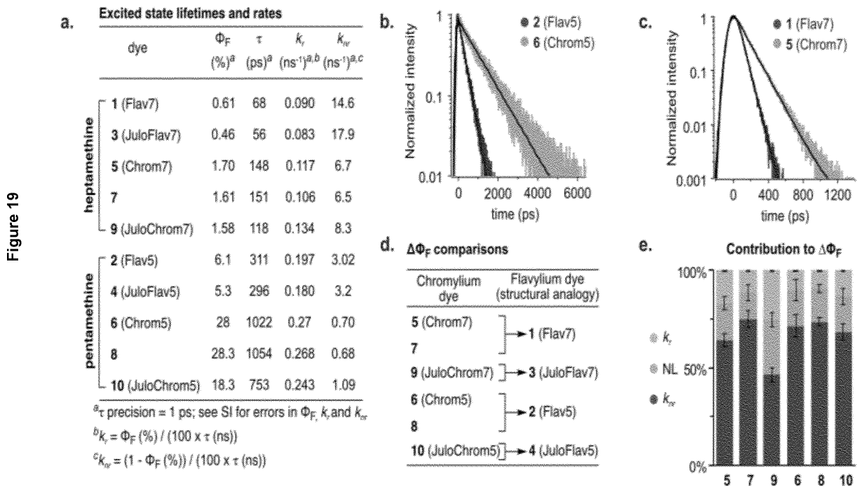

Intrigued by the significantly improved quantum yields of the chromenylium dyes, we investigated the fluorescence lifetimes (τ) of dyes 1-10 by time-correlated single-photon counting (TCSPC). We found that in all cases, τ increased considerably for the chromenylium dyes compared to the flavylium dyes, corresponding with the increase in OF. A ˜2.5-fold increase in τ ˜140 μs for the heptamethines (5,7,9) and a ˜3.1-fold enhancement to τ⁻¹ ns for the pentamethines 6 and 8 (e.g., FIGS. 19 a-c) is observed. A slightly shorter τ(˜750 μs), and corresponding lower Φ_{F} is determined for the more red-shifted pentamethine, 10. By calculating the radiative (kᵣ) and non-radiative (kₙᵣ) rates from these data, it was discovered that while modest increases in kᵣ are observed for the brighter dyes, the kₙᵣ are more drastically affected, with an average of 2.3-fold decrease in kᵣ,for the heptamethines and a 3.8-fold decrease in kₙᵣ for the pentamethines when comparing chromenylium to flavylium dyes (e.g., FIG. 19a). This effect can be visualized by comparing analogous chromenylium and flavylium structures (e.g., FIG. 19d) and observing the relative contribution of changes in kᵣ or kₙᵣ to ΔΦ_{F} between the two scaffolds. (e.g., FIG. 19e). As the decreased kₙᵣ is the dominant contribution to an increased OF in the chromenylium dyes, we hypothesize that the structural change between the two scaffolds could be reducing vibrational modes relevant to internal conversion. Although unable to decouple the vibrational mode effects from those imparted by the energy gap law as a result of a larger HOMO-LUMO gap, the significantly increased Φ_{F} seen here that is absent in other polymethine dyes with a similar wavelength of absorption, supports that reducing vibrational modes is playing an important role in the increase in emissive behavior.

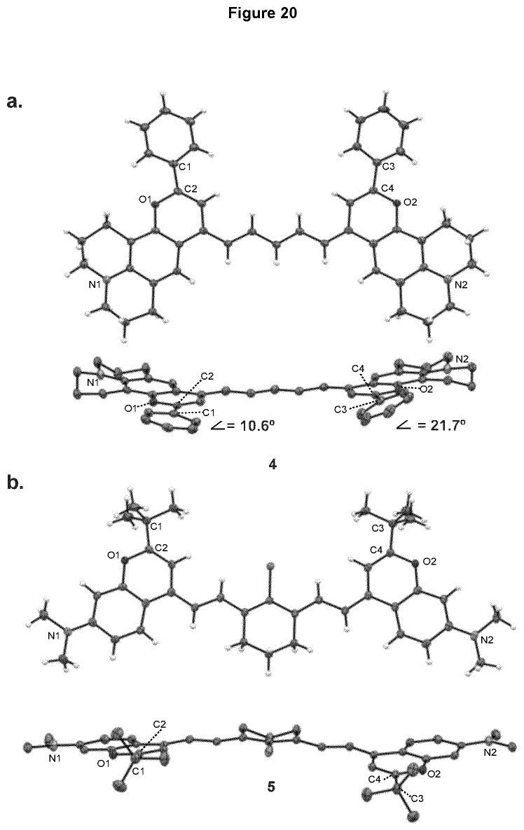

To further understand the differences between the two dye types, the X-ray crystal structures of dyes 4 and 5 as exemplars of the flavylium and chromenylium scaffolds were obtained, respectively (e.g., FIG. 20). Focusing on the 2-position of the heterocycle, the phenyl group on the flavylium dye 4 lies ˜10-20° (C1-C2; C3-C4) has an average bond length of 1.47 Å, indicating single-bond character, and suggesting rotation in solution. In contrast, the C2-C1 and C4-C3 bond lengths on 5 are 1.51 Å, aligning with the expected C(sp²)-C(sp³) bond lengths. Despite its out-of-plane character, the 2-phenyl ring significantly contributes to increased conjugation in the flavylium dyes, indicated by the more red-shifted photophysics. Taken together, the crystal structure and fluorescence lifetime analyses suggest that the added degrees of freedom in the chromophore associated with the 2-phenyl substituent contributes to the increased kₙᵣ in the flavylium dyes.

In vitro comparative experiments highlight the high brightness of Chrom7 (5) and JuloChrom5 (10):

While photophysical characterization can be essential for understanding chromophore properties, when moving to an in vivo system, there are many additional parameters that might contribute to a dye's performance, including delivery strategy, interaction with biological tissues, and the excitation and detection parameters of the imaging configuration. To begin to understand the translation to in vivo experiments, an excitation-multiplexed SWIR imaging configuration was used to compare emission of the fluorophores when excited at relevant wavelengths. The imaging set-up includes excitation lasers that correspond to each channel (e.g., i-iv, FIG. 17a) (785, 892, and 968, 1065 nm) with irradiation scaled to the approved values, as outlined by the International Commission on Non-Ionizing Radiation Protection (ICNIRP) guidelines. The guidelines indicate that within the spectral region of interest (˜785 nm-1065 nm) higher photon doses are tolerated as the wavelength is increased. These results in a factor of 3.38-fold higher irradiation power allowed at 1000 nm compared to 785 nm. The excitation lasers are diffused and delivered uniformly to the biological sample. Importantly, the excitation-multiplexed imaging configuration provides fast switching of the excitation lasers (on the μs time scale), allowing for real-time multicolor imaging. Collection is achieved through a single-channel (“color-blind”) SWIR detector that records individual frames for each excitation channel in real-time; multiplexed frames are obtained by merging the adjacent frames from each excitation channel. Multiplexed frame rates are related to the exposure time multiplied by the number of channels used in the experiment. Thus, to obtain video-rate speeds, bright probes and short exposure times are necessary.

To compare brightness of the chromenylium dyes in vitro, dyes 5, 6, 9 and 10 were dissolved in organic solvent (DCM) at 0.25 μM, and measured the emission, with 1000 nm longpass (LP) filtering on an InGaAs camera upon sequential excitation with 785, 892, and 968 nm lasers. ICG (in EtOH), 4, and MeOFlav7 were used as benchmarks to the chromenylium dyes for the three excitation channels, i-iii respectively. When the raw count data are normalized to the exposure time used in image collection, it is clear that Chrom7 (5), in channel iii, produces the brightest SWIR emission in organic solvent with excitation at 968 nm, providing a ˜3-fold advantage in brightness over MeOFlav7, previously employed for 3-color imaging. The other two channels offered lower signal overall, but the best performers in channels i and ii were ICG and JuloFlav5 (4), respectively.

Next, to more closely approximate in vivo performance, each chromenylium or flavylium dye were formulated into water-soluble PEG-phospholipid micelles, a biocompatible nanomaterial for delivery. Brightness of solutions with equal dye concentration (flavylium and chromenylium dyes in micelles; ICG) were evaluated when dispersed in water (e.g., FIG. 20a), fetal bovine serum (FBS) (e.g., FIG. 20b), and sheep blood (e.g., FIG. 20c). As many polymethine dyes, most notably ICG, are known to increase in brightness in serum and blood, it is essential to perform benchmarking experiments in these biologically-relevant media.

Results changed drastically compared to those in the organic solvent experiment, likely due to variable amounts of aggregation or interactions within the micelles and/or biological media. Notably, in all media, two dyes stand out with significantly high SWIR brightness, JuloChrom5 (10), when excited at 892 nm, and Chrom7 (5), when excited at 968 nm. While ICG is the brightest SWIR emitter upon 785 nm excitation in both FBS and blood, both chromenylium dyes produce greater signal in their respective channels (ii and iii) compared to that of ICG (in channel I). In blood, the most representative media, this quantitates to a ˜2.8-fold and ˜1.7-fold, improvement in signal over ICG, for 10 and 5 respectively. Additionally, comparing the performance of the chromenylium dyes between media, it is clear that, similar to ICG, an increase in brightness is occurring in FBS and blood compared to water. Interestingly, the opposite effect is observed for MeOFlav7, likely due to instability in these more complex environment.

Similar experiments using either equal laser power, or equal photon number at all excitation wavelengths have an expected reduced performance at the longer excitation wavelengths compared to those using ICNIRP-suggested powers, but still predict a ˜2-fold brightness advantage of JuloChrom5 (10) over ICG.

High brightness of JuloChrom5 (10) is translated to in vivo experiments:

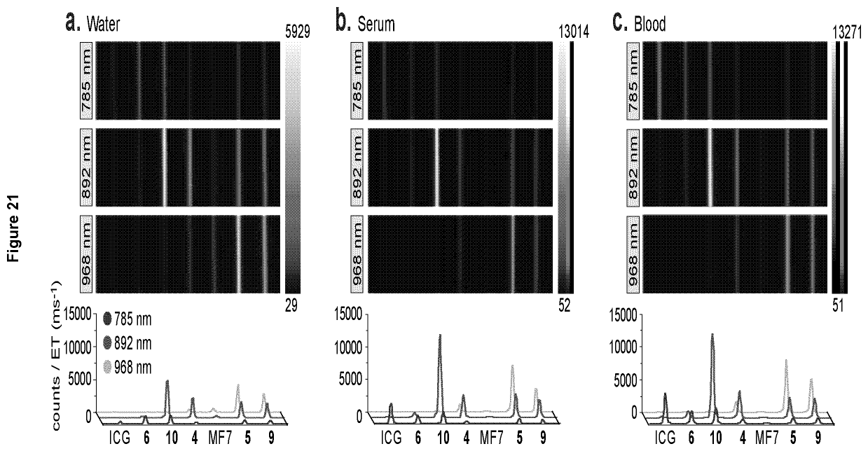

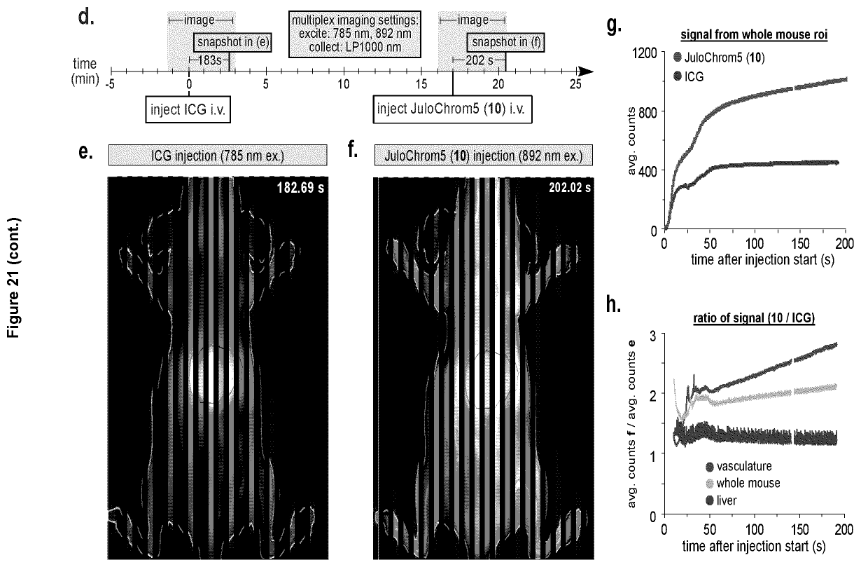

To most closely assess the brightness performance for SWIR imaging, an in vivo comparative experiment between the highest performing chromenylium dye, JuloChrom5 (10) and ICG was designed. To note, while many SWIR imaging agents have been compared to the benchmark dye, ICG, these comparisons are often difficult due to the diverse photophysical and biological properties of different emitters. In this case, the in vivo comparison is complicated by differing biodistribution properties of the two dyes. While this difference cannot be entirely decoupled from the conclusions, it was aimed to reduce uncertainty in other aspects of the experiment and the analysis. Capitalizing on the multiplexing capabilities of the two dyes to perform a comparative experiment of both agents in a single mouse, eliminating biological sample variance was achieved. As signal from ICG upon 892 nm excitation is negligible with these acquisition settings, temporally-separated tail-vein injections of equal moles of ICG were performed, followed by JuloChrom5 (10) into mice and imaged each injection in two channels, with 785 nm and 892 nm excitation and collection with 1000 nm LP filtering (e.g., FIG. 21d-f). Normalizing each acquisition to the injection start time, the signal over time over the whole mouse (yellow), a section of the vasculature (red), and the liver (black) were quantified. Looking at the whole mouse region of interest (roi) (e.g., FIG. 21g), signal from JuloChrom5 (10) is significantly higher than signal from ICG. However, the ratio of counts between 10 and ICG (e.g., FIG. 21h) increases when looking only at the vasculature. Conversely, the ratio (10 to ICG) decreases when observing the liver, due to the faster hepatic clearance time of ICG compared to the PEG-coated micelles. Despite this difference, 10 still demonstrates slightly higher signal than ICG in the liver over the observed time frame. While differential biodistribution could result in variable probe depths and differing amounts of attenuation, the higher signal among several regions of interest in vivo, combined with the more controlled in vitro quantification leads us to conclude that JuloChrom5 (10) displays an overall higher signal in the SWIR compared to ICG. Importantly, the high brightness of 10 enables imaging with high signal-to-noise ratios (SNR) at low exposure times (1.6-2.0 ms). Accordingly, it was possible to now image a whole mouse in a single color at frame rates up to 300 fps, limited by the collection rate of the current detector. Notably, other dyes in the series, for example, Chrom5 (6) and Chrom 7 (5), can also be employed to image in a single color at 300 fps, with good SNR and similar acquisition parameters, making fast SWIR imaging possible in each of the NIR-excitation channels i-iii.

Improvement in Speed and Number of Channels in Multiplexed In Vivo SWIR Imaging:

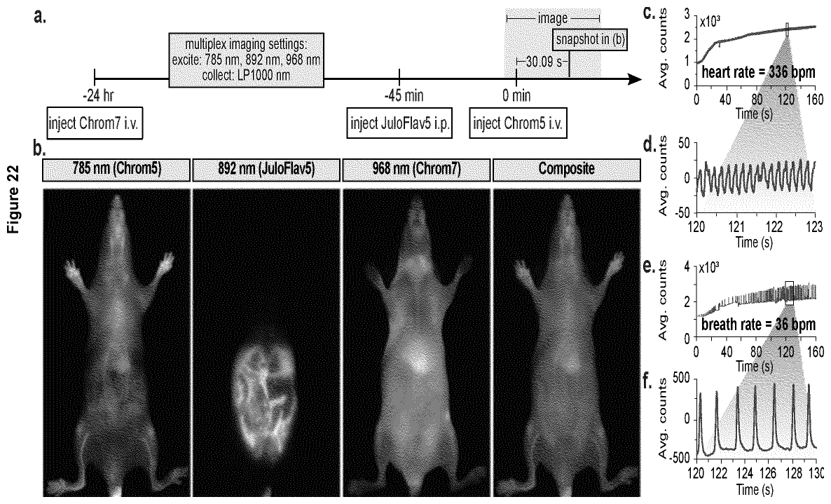

Next, it was examined how the brighter dyes can be used to improve excitation-multiplexed, single-channel detection SWIR imaging. Previously, it was demonstrated that 3-color imaging in real time (up to 27 fps). Here, it was aimed to improve the temporal resolution of the method as well as increase the number of channels at which orthogonal signals can be detected. The high brightness of the chromenylium dyes and the flavylium pentamethines, coupled with the varied absorption profiles across the far-NIR provides several candidate dyes for multiplexed imaging using channels i-iii. First, Chrom5 (6), JuloFlav5 (4), and Chrom7 (5) were used together, preferentially excited by 785, 892, and 968 nm lasers, respectively, with collection using 1000 nm LP filtering (e.g., FIG. 22). In this three-color experiment, Chrom7 (5) was injected i.v. 24 hrs before the experiment to allow for clearance from the circulatory system and subsequent accumulation in deep tissues to provide structural reference. JuloFlav5 (4) was injected into the intraperitoneal space 45 min before imaging, and finally Chrom5 (6) was injected intravenously to label the vasculature. Images with a good SNR (e.g., FIG. 22b) were collected with 3.3 ms ET, and 100 fps multiplexed frame rate (multiplexed frame rate=1/(n×ET), where n=number of channels), which is over 3× the speed obtained previously. The fast acquisition can be visualized by observing the heart rate and breathing rate which can be obtained with high temporal resolution (e.g., FIG. 22c-f). Multiplexing at these high frame rates ensures that macroscopic biological motion is negligible within the collection time for each frame that contributes to the composite image and will offer increased benefits in applications such as image-guided surgery or imaging animals in the absence of anesthesia.

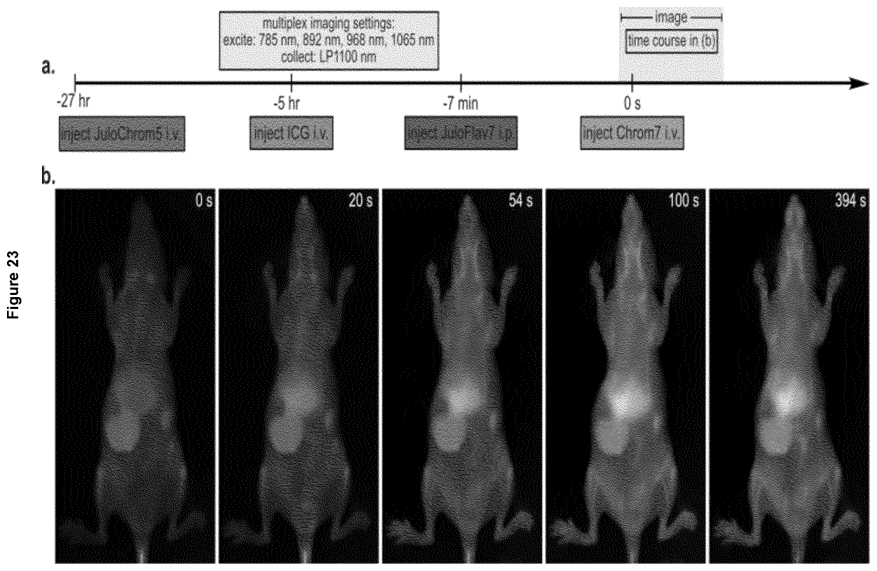

Finally, the new NIR fluorophores allowed the addition of a forth channel such that 4-color SWIR imaging could be performed for the first time. ICG, JuloChrom5, (10) Chrom7 (5), and JuloFlav7 (3) were used as spectrally distinct fluorophores with preferential excitation at 785 nm, 892 nm, 968 nm, and 1065 nm, respectively, and collection with 1100 nm LP filtering (e.g., FIG. 23). First, JuloChrom5 (10) was injected i.v. 27 hours prior to serve as a structural reference. Next, ICG was injected i.v., and let clear for 5 hours through the liver into the intestine. JuloFlav7 was then administered into the i.p. space 7 min before imaging, and finally, Chrom7 (5) was injected i.v. to obtain the time-course images of the injection displayed in e.g., FIG. 23b. For multiplexed experiments employing 1065 nm excitation, longer exposure times were needed due to the smaller, more red-shifted collection window decreasing the percentage of emissive-tails of the dyes collected. Regardless, signal in each channel was sufficient for collection at 30 fps, with a 7.8 ms ET for each channel. Notably, the 4 color-experiment was able to be performed at similar speeds to previously reported 3-color experiments which used 1064 nm excitation. The lower exposure times used (7.8 ms vs. 10 ms) were possible due to the higher brightness of the NIR-excitable dyes compared to MeOFlav7 and the scaled power densities of the excitation wavelengths. Additionally, due to the more complex nature of 4-color imaging data, we performed linear unmixing using vials of each probe as a training set for an algorithm that can be applied to the in vivo data. Prior to this report, non-invasive, real-time, 4-color optical imaging of biological processes in mammals was unprecedented. Here, by improving the brightness of dyes in key wavelength regions and integrating their use into excitation-multiplexed SWIR imaging, opportunities for non-invasive and high-resolution imaging of multiple biological parameters in vivo was opened.

Conclusions:

The ability to non-invasively and longitudinally track multiple probes within living mammals will be key to studying causes and interventions of human disease. Fluorescence is an optimal tool for high resolution and high sensitivity detection, but non-invasive experiments are limited by light scattering in tissue. Longer wavelength detection benefits from increased penetration depth and contrast, but lacks bright enough probes that can be concurrently detected orthogonally. Here, we designed and synthesized seven new polymethine dyes with flavylium or chromenylium heterocycles, which are brighter than their predecessors. The pentamethine and heptamethine chromenylium dyes benefit from significantly higher quantum yields due to decreased non-radiative rates compared to the flavylium dyes. The dye JuloChrom5 (10), excitable at 892 nm, is brighter than ICG for in vivo experiments. The panel of bright dyes enables single-channel imaging at up to 300 fps, the fastest SWIR imaging to date, at excitation wavelengths of 785, 892, and 968 nm. Dyes excitable at orthogonal excitation wavelengths can be used together providing three-channel imaging at up to 100 fps, the fastest multi-color SWIR imaging to date. Combining these dyes with ICG and JuloFlav7 (3), video-rate imaging in mammals in 4-colors is demonstrated for the first time. The primary advances in this study, namely fundamentally increasing the brightness of long-wavelength polymethine dyes, and exploring their contribution to the technological advance of multiplexed SWIR imaging, put forth a greater understanding of how to increase the performance and utility of long wavelength probes to visualize complex organisms.

### REFERENCES

1. Carr, Jessica, et al. WO 2017/160643
2. Carr, Jessica, et al. PNAS Absorption by water increases fluorescence image contrast of biological tissue in the shortwave infrared, Sep. 11, 2018. (37) 9080-9085.
3. Spectral imaging. zeisscampus.magnet.fsu.edu. [Online] 2019 http://zeiss-campus.magnet.fsu.edu/tutorials/spectralimaging/lambdastack/indexflash.html

### CONCLUDING REMARKS

One skilled in the art would readily appreciate that the present invention is well adapted to carry out the objects and obtain the ends and advantages mentioned, as well as those inherent therein. Further, it will be readily apparent to one skilled in the art that varying substitutions and modifications may be made to the invention disclosed herein without departing from the scope and spirit of the invention. The systems and methods described herein are presently representative of certain embodiments, are exemplary and are not intended as limitations on the scope of the invention. Changes therein and other uses will occur to those skilled in the art which are encompassed within the spirit of the invention are defined by the scope of the claims. The listing or discussion of a previously published document in this specification should not necessarily be taken as an acknowledgement that the document is part of the state of the art or is common general knowledge.

The invention illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by exemplary embodiments and optional features, modification and variation of the inventions embodied herein may be resorted to by those skilled in the art, and that such modifications and variations are considered to be within the scope of this invention.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein. Other embodiments are within the following claims.

What is claimed is:

1. A method for multiplexed imaging of a biological sample location, said method comprising:
i) exposing a portion of said sample location to a first light pulse, wherein said first light pulse having:
(a) a first state; or
(b) a first wavelength;
in order to illuminate or excite a first component, chemical composition, surface and/or region in the portion of said sample location;
ii) exposing the portion of said sample location to at least a second light pulse having:
(c) a second state, which is different from the first state of (a); or
(d) a second wavelength, which is different from the first wavelength of (b);
in order to illuminate or excite a second component, chemical composition, surface and/or region in the portion of said sample location; whereins said second component, chemical composition, surface and/or region is different from said first component, chemical composition, surface and/or region;
wherein the first light pulse and the second and/or subsequent light pulse are provided sequentially;
iii) detecting light reflected or emitted by the first and the second components, chemical compositions, surfaces and/or regions in the portion of said sample location by an imaging device, wherein the peak emission wavelength of at least one component, chemical composition, surface and/or region in the portion of said sample location lies outside of the detection range of the imaging device, the detection process including:
aa) switching the imaging device, in a sequential manner, between a first configuration during which the imaging device is responsive to a first electromagnetic radiation and a second configuration during which the imaging device is responsive to a second electromagnetic radiation, wherein said first and second electromagnetic radiations are not identical;
wherein the switching of the first configuration is triggered by the provision of the light pulse.

2. The method according to any one of preceding claims, further comprising: providing an optical filter in the optical path between the portion of said sample location and the imaging device, the optical filter being configured to block the first excitation light and the second excitation light.

3. The method according to any one of preceding claims, wherein the optical filter is configured as a longpass or bandpass filter with a cut-on wavelength in the micrometer range.

4. The method according to any one of preceding claims, wherein the detection range of the imaging device lies in the micrometer range, preferably in the short-wave infrared (SWIR) range.

5. The method according to any one of preceding claims, wherein the first and the second excitation light pulses are provided at the same rate or at the different rate.

6. The method according to any one of preceding claims, wherein the pulse length of the first and second excitation light pulses is: i) 10 ms or shorter; ii) up to several (e.g., 1, 2, 3, 4, 5, 6, 7, 8, 9, 10) seconds; or iii) up to several (e.g., 1, 2, 3, 4, 5, 6, 7, 8, 9, 10) minutes.

7. The method according to any one of preceding claims, wherein the duty cycle of the first and second pulses is: i) 1% or less; or ii) up to 100%.

8. The method according to any one of preceding claims, wherein the first excitation light pulse/s and the second excitation light pulse/s impinge on the portion of said sample location from the same spatial direction.

9. The method according to any one of preceding claims, wherein the first excitation light pulse/s and the second excitation light pulse/s impinge on the portion of said sample location from different spatial directions.

10. The method according to any one of preceding claims, as long as dependent on claim 3, wherein the peak emission wavelength of at least one of the dyes lies below the cut-on wavelength of the longpass filter.

11. The method according to any one of preceding claims, wherein for any wavelength within the detection range of the imaging device the emission intensity of at least one of the dyes amounts to: i) 1% or less, preferably to 0.1% or less, of the peak emission intensity of the respective dye; ii) 30% or less of the peak emission intensity of the respective dye; iii) up to 100% of the peak emission intensity of the respective dye; or iv) in the range between 30%-100% of the peak emission intensity of the respective dye.

12. The method according to any one of preceding claims, wherein the switching of the device into the first configuration is triggered by the provision of the light pulse/s such that the imaging device is switched into the first configuration simultaneously with or within 2 microseconds after the emission of any one of the first and second excitation light pulse/s.

13. The method according to any one of preceding claims, wherein said method: i) does not comprise a moving and/or switching an optical filter or an array of optical filters; or ii) comprising providing only one optical filter; and/or iii) is a method for reduction of melanin absorption in the SWIR and/or a method for a non-invasive imaging of tissues and/or organisms in the presence of melanin.

14. A system for multiplexed imaging of a biological sample location, said system comprising:
i) a first light source (e.g., a laser, LED or lamp) configured to operate at a first wavelength;
ii) at least a second light source (e.g., a laser, LED or lamp) configured to operate at a second wavelength;
iii) an imaging device configured to detect electromagnetic radiation;
iv) a control unit coupled to the first light source (e.g., a laser, LED or lamp), the second light source (e.g., a laser, LED or lamp) and the imaging device, wherein the control unit is configured to control the first light source to provide first excitation light pulse/s and to control the second light source to provide second excitation light pulse/s in sequential manner; wherein the control unit is further configured to switch the imaging device in a sequential manner, between a first state during which the imaging device is responsive to a first electromagnetic radiation and a second state during which the imaging device is responsive to a second electromagnetic radiation, wherein said first and second electromagnetic radiations are not identical;
wherein the system is configured such that the switching of the imaging device into the first state is triggered by the provision of the light pulse/s.

15. The system according to any one of preceding claims, wherein said system comprises two or more light sources (e.g., lasers, LEDs or lamps), preferably said light sources are configured to be operated (e.g., be switched on) simultaneously during pulses (e.g., during definable pulses).

16. The system according to any one of preceding claims, wherein said system: i) does not comprise a movable optical filter or a movable array of optical filters; or ii) comprises only one optical filter; and/or iii) said system is for reduction of melanin absorption and/or for a non-invasive imaging of tissues and/or organisms in the presence of melanin.
